(19) United States
(12) Patent Application Publication
(10) Pub. No.: US 2025/0306444 A1
(43) Pub. Date: Oct. 2, 2025

(54) PROJECTOR AND PROJECTION SYSTEM

(71) Applicant: SEIKO EPSON CORPORATION, Tokyo (JP)

(72) Inventors: Eiji MORIKUNI, Matsumoto-shi (JP); Koya Shiratori, Matsumoto-shi (JP)

(73) Assignee: SEIKO EPSON CORPORATION, Tokyo (JP)

(21) Appl. No.: 19/094,128

(22) Filed: Mar. 28, 2025

(30) Foreign Application Priority Data
Mar. 29, 2024 (JP) 2024-055570

(51) Int. Cl. G03B 21/20; G03B 21/00

(52) U.S. Cl. CPC G03B 21/2013; G03B 21/006; G03B 21/2033; G03B 21/2066; G03B 21/208

(57) ABSTRACT

A projector according to an aspect of the present disclosure includes: a visible light source device configured to emit visible light containing first light having a first wavelength; an invisible light source device configured to emit invisible light; a first light combining element configured to combine the first light and the invisible light into first combined light; a first liquid crystal panel configured to modulate the first combined light; a first incident-side polarizing plate configured to transmit the first light between the visible light source device and the first light combining element; a first emission-side polarizing plate configured to transmit the first combined light at a light emission side of the first liquid crystal panel; and a projection optical system configured to project the first combined light emitted from the first liquid crystal panel.

The present application is based on, and claims priority from JP Application Serial Number 2024-055570, filed Mar. 29, 2024, the disclosure of which is hereby incorporated by reference herein in its entirety.

### BACKGROUND

### 1. Technical Field

The present disclosure relates to a projector and a projection system.

### 2. Related Art

In an image display device such as a projector, in order to control a visible image to be displayed, the visible image and an invisible image such as an infrared image may be superimposed on a screen, and the control may be performed based on information that can be acquired from the invisible image. For example, JP-A-2008-176195 discloses a projector that separates infrared light from light emitted from a light source, and superimposes the infrared light on a projection image via a dedicated light modulation element.

In the device disclosed in the above-described JP-A-2008-176195, an optical path of invisible light is arranged at a position different from an optical path of visible light. Therefore, there is a problem that movement or deviation of a projection image caused by a factor on optical paths of visible light of various colors cannot be accurately reproduced on an optical path of the invisible light, and it is difficult to accurately adjust the projection image.

### SUMMARY

In order to solve the above problem, a projector according to a first aspect of the present disclosure includes: a visible light source device configured to emit visible light containing first light having a first wavelength; an invisible light source device configured to emit invisible light; a first light combining element configured to combine the first light and the invisible light into first combined light; a first liquid crystal panel configured to modulate the first combined light; a first incident-side polarizing plate configured to transmit the first light between the visible light source device and the first light combining element; a first emission-side polarizing plate configured to transmit the first combined light at a light emission side of the first liquid crystal panel; and a projection optical system configured to project the first combined light emitted from the first liquid crystal panel.

A projection system according to a second aspect of the present disclosure includes: the projector; and an imaging device configured to image a projection image of the invisible light projected from the projector, in which the projector includes a movement mechanism configured to move the projection optical system to change a position of the projection image, and a control unit configured to control the movement mechanism based on an image imaged by the imaging device.

A projection system according to a third aspect of the present disclosure includes: the projector; and an imaging device configured to image a projection image of the invisible light projected from the projector, in which the projector includes a control unit configured to change a region of an image formed in an image display region of the first liquid crystal panel based on an image imaged by the imaging device.

### BRIEF DESCRIPTION OF THE DRAWINGS

FIG. 1 is a schematic view showing a projector according to an embodiment.

FIG. 2 is a schematic plan view showing a light transmitting member according to the embodiment.

FIG. 3 is a schematic cross-sectional view showing the light transmitting member according to the embodiment.

FIG. 4 is a conceptual diagram showing a polarizing state of first combined light in the projector according to the embodiment.

FIG. 5 is a schematic view showing a positional relationship between a projection optical system, a first liquid crystal panel, and the light transmitting member in the projector according to the embodiment.

FIG. 6 is a schematic plan view showing a light transmitting member according to Modification 1.

FIG. 7 is a schematic view showing a projector according to Modification 2.

FIG. 8 is a schematic cross-sectional view showing a depolarizing plate used in the projector according to Modification 2.

FIG. 9 is a schematic view showing a first laser light source and a second laser light source that can be adopted in Modification 2.

FIG. 10 is a diagram showing a polarizing state of light emitted from a light emitting region shown in FIG. 9 on the Poincare sphere.

FIG. 11 is a schematic view showing a projector according to Modification 3.

FIG. 12 is a schematic view showing a projector according to Modification 4.

FIG. 13 is a schematic view showing a projection system according to Modification 5, and showing a projection image in an initial state or after image correction is performed.

FIG. 14 is a schematic view showing the projection system according to Modification 5, and showing a projection image before image correction is performed.

### DESCRIPTION OF EMBODIMENTS

Hereinafter, an embodiment of the present disclosure will be described with reference to the drawings.

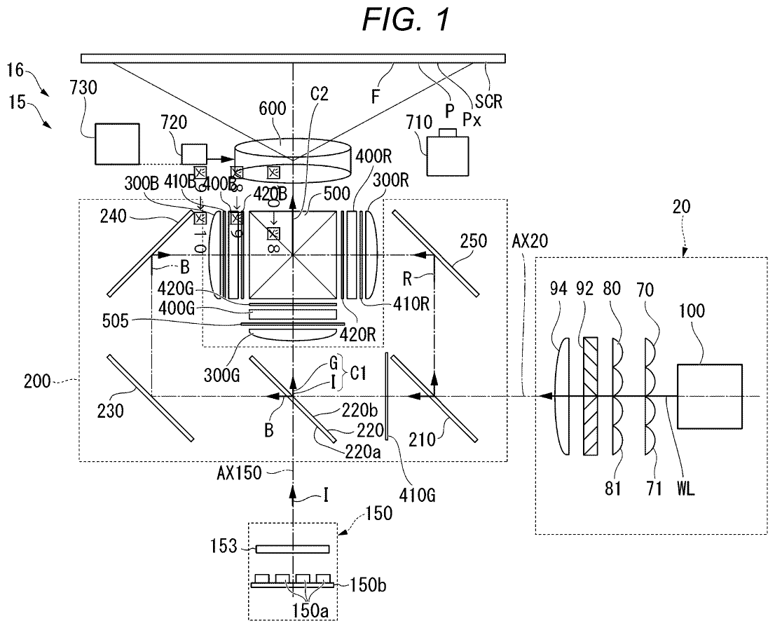

FIG. 1 is a schematic view showing a configuration of a projection system 16 according to the embodiment. In the following drawings, components may be drawn at different dimensional scales for clarity of the components.

### Projection System

The projection system 16 includes a projector 15 and an imaging device 710. The projector 15 projects a projection image P of visible light and a projection image Px of infrared light I including a predetermined pattern F in a superimposed manner on a screen SCR disposed in front of the projector 15. The configuration of the projector 15 will be described in detail later.

The imaging device 710 is, for example, a camera including an imaging element that can image the infrared light I. The imaging device 710 is disposed outside the projector 15, and is connected to the projector 15 in a wired or wireless manner. The imaging device 710 is disposed at a position where the imaging device 710 does not block light projected from the projector 15. Alternatively, the imaging device 710 may be incorporated inside the projector 15.

The imaging device 710 images the projection image P projected by the projector 15. As will be described later, the projection image P is formed by second combined light C2 obtained by combining visible light and the infrared light I which is invisible light. Therefore, the projection image Px of the infrared light I is superimposed on the projection image P. The imaging device 710 images the projection image Px of the infrared light I. A control unit 730 of the projector 15 is connected to the imaging device 710. The control unit 730 corrects a position of the projection image P based on the projection image Px of the infrared light I imaged by the imaging device 710.

In the present specification, the visible light is, for example, light having a wavelength of 360 nm or more and 830 nm or less. The invisible light is, for example, ultraviolet light having a wavelength of less than 360 nm or red light having a wavelength of more than 830 nm. Although the infrared light I is used as the invisible light in the embodiment, ultraviolet light may be used as the invisible light.

### Projector

As shown in FIG. 1, the projector 15 includes a visible light source device 20, an invisible light source device 150, a color separation optical system 200, field lenses 300R, 300G, and 300B, liquid crystal panels 400R, 400G, and 400B, incident-side polarizing plates 410R, 410G, and 410B, emission-side polarizing plates 420R, 420G, and 420B, a light transmitting member 505, a cross dichroic prism (second light combining element) 500, a projection optical system 600, a movement mechanism 720, and the control unit 730.

In the following description, when the plurality of liquid crystal panels 400R, 400G, and 400B are distinguished from one another, they are referred to as the first liquid crystal panel 400G, the second liquid crystal panel 400R, and the third liquid crystal panel 400B. When the plurality of incident-side polarizing plates 410R, 410G, and 410B are distinguished from one another, they are referred to as the first incident-side polarizing plate 410G, the second incident-side polarizing plate 410R, and the third incident-side polarizing plate 410B. When the plurality of emission-side polarizing plates 420R, 420G, and 420B are distinguished from one another, they are referred to as the first emission-side polarizing plate 420G, the second emission-side polarizing plate 420R, and the third emission-side polarizing plate 420B.

### Visible Light Source Device

The visible light source device 20 emits white light WL obtained by combining red light R, green light G, and blue light B, which are visible light. In the embodiment, the green light G is first light having a first wavelength. The red light R is second light having a second wavelength different from the first wavelength. The blue light B is third light having a third wavelength different from both the first wavelength and the second wavelength. The first wavelength may be a wavelength range that is visually recognized as the green light G, the second wavelength may be a wavelength range that is visually recognized as the red light R, and the third wavelength may be a wavelength range that is visually recognized as the blue light.

The visible light source device 20 includes a light source unit 100, a first lens array 70, a second lens array 80, a polarization conversion element 92, and a superimposing lens 94. The light source unit 100 outputs the white light WL. The white light WL emitted from the light source unit 100 is collimated and is incident on the first lens array 70.

The first lens array 70 includes a plurality of small lenses 71 for dividing the white light WL emitted from the light source unit 100 into a plurality of partial light fluxes. The plurality of small lenses 71 are arranged in a matrix in a plane orthogonal to an optical axis AX20 of the light source unit 100.

The second lens array 80 includes a plurality of small lens 81 corresponding to the plurality of small lens 71 of the first lens array 70. The plurality of small lenses 81 are arranged in a matrix in a plane orthogonal to the optical axis AX20. The second lens array 80 forms images of the respective small lenses 71 of the first lens array 70 in the vicinity of respective image forming regions of the liquid crystal panels 400R, 400G, and 400B, together with the superimposing lens 94.

The polarization conversion element 92 includes a polarization separation layer, a reflection layer, and a phase difference plate, none of which is shown. The polarization conversion element 92 converts a partial light flux emitted from the second lens array 80 into linearly polarized light. The polarization conversion element 92 is formed in a plate shape as a whole. A plate surface of the polarization conversion element 92 is disposed parallel to a plane orthogonal to the optical axis AX20. The polarization separation layer of the polarization conversion element 92 transmits one linearly polarized component contained in the partial light flux emitted from the second lens array 80, and reflects the other linearly polarized component in a direction perpendicular to the optical axis AX20. The reflection layer of the polarization conversion element 92 layer reflects the other linearly polarized component reflected by the polarization separation layer in a direction parallel to the optical axis AX20. The phase difference plate of the polarization conversion element 92 converts the other linearly polarized component reflected by the reflection layer into the one linearly polarized component.

The superimposing lens 94 condenses partial light fluxes from the polarization conversion element 92 and superimposes the partial light fluxes in the vicinity of the image forming regions of the liquid crystal panels 400R, 400G, and 400B. The first lens array 70, the second lens array 80, and the superimposing lens 94 constitute an integrator optical system. The integrator optical system homogenizes an in-plane light intensity distribution of the white light WL emitted from the visible light source device 20 in the image forming regions of the liquid crystal panels 400R, 400G, and 400B.

### Invisible Light Source Device

The invisible light source device 150 emits, for example, the infrared light I as invisible light. The invisible light source device 150 may emit ultraviolet light as the invisible light.

The invisible light source device 150 includes a substrate 150b, a plurality of light emitting diode light sources 150a mounted on the substrate 150b, and a condensing lens (homogenizing optical element) 153.

The light emitting diode light source 150a is a light emitting diode (LED) that emits the infrared light I. The plurality of light emitting diode light sources 150a are arranged in a plane orthogonal to an optical axis of the infrared light I. The invisible light source device 150 may include only the single light emitting diode light source 150a. In this case, the light emitting diode light source 150a is disposed on the optical axis of the infrared light I.

In the embodiment, a wavelength of the infrared light I emitted by the light emitting diode light source 150a is 930 nm or more and 950 nm or less. In this case, the projector 15 projects the projection image Px of the infrared light I having a wavelength of 930 nm or more and 950 nm or less on the screen SCR. In light in the near-infrared region contained in sunlight, energy of light having a wavelength of about 940 nm is low. In other words, in sunlight, a light amount of the infrared light I having a wavelength of about 940 nm is smaller than that of light having other wavelengths. According to the embodiment, by using light having a wavelength of 930 nm or more and 950 nm or less that is around 940 nm as the infrared light I, it is possible to prevent a decrease in contrast of a pattern F of the infrared light I due to the influence of sunlight when the screen SCR is irradiated with the infrared light I. As a result, it is possible to prevent a decrease in accuracy of position detection using the pattern F of the infrared light I.

In the embodiment, the wavelength of the infrared light I emitted by the light emitting diode light source 150a may be 840 nm or more and 860 nm or less. In this case, the projector 15 projects the projection image Px of the infrared light I having a wavelength of 840 nm or more and 860 nm or less on the screen SCR. In general, a wavelength of light that can be recognized by a person is 360 nm or more and 830 nm or less. Therefore, by using the infrared light I having a wavelength of 840 nm or more and 860 nm or less as the invisible light, the infrared light I is not recognized by a viewer. A light source using a light emitting diode or laser can emit light close to visible light with high efficiency. According to the embodiment, by using light having a wavelength of 840 nm or more and 860 nm or less as the infrared light I, energy efficiency of the invisible light source device 150 can be increased, and power consumption of the projector 15 can be reduced. Further, since a light source that emits the infrared light I having a wavelength of 840 nm or more and 860 nm or less is widely used as a light source of invisible light, it is possible to stably procure parts at low cost, and it is possible to reduce manufacturing costs of the projector 15.

The condensing lens 153 is disposed on a light emission side of the light emitting diode light source 150a. For example, one convex meniscus lens or a plurality of convex meniscus lenses can be used as the condensing lens 153. The convex meniscus lens is preferably an aspherical lens formed of glass or resin in order to improve light condensing performance. The condensing lens 153 transmits the infrared light I emitted from the light emitting diode light source 150a and homogenizes an in-plane light amount of the infrared light I.

In the embodiment, a case where the condensing lens 153 is adopted as a homogenizing optical element is described. However, a configuration of the homogenizing optical element is not limited to the embodiment. For example, a diffractive optical element (DOE) such as a holographic optical element (HOE) may be adopted as the homogenizing optical element. In this case, a surface pattern for forming a homogenizing irradiation pattern is formed on the diffractive optical element serving as the homogenizing optical element, and the diffractive optical element diffracts the infrared light I transmitted through the diffractive optical element to homogenize the in-plane light amount of the infrared light I. When the diffractive optical element is adopted as the homogenizing optical element, a laser light source is used as a light source that emits the infrared light I.

### Color Separation Optical System

The color separation optical system 200 includes dichroic mirrors 210 and 220 and reflection mirrors 230, 240, and 250. The color separation optical system 200 separates the white light WL emitted from the visible light source device 20 into red light R, green light G, and blue light B, which are visible light, and guides the red light R, the green light G, and the blue light B to the liquid crystal panels 400R, 400G, and 400B, respectively. Further, the infrared light I is introduced into the color separation optical system 200 according to the embodiment and is combined with the green light G. Therefore, a part of the color separation optical system 200 according to the embodiment also functions as a combining light optical system that combines visible light and invisible light.

In the following description, when the plurality of dichroic mirrors 210 and 220 are distinguished from each other, they are referred to as the first dichroic mirror 210 and the second dichroic mirror 220. Similarly, when the plurality of reflection mirrors 230, 240, and 250 are distinguished from one another, they are referred to as the first reflection mirror 230, the second reflection mirror 240, and the third reflection mirror 250.

The first dichroic mirror 210 is disposed on the optical axis AX20 of the visible light source device 20 in a manner of facing the visible light source device 20. The white light WL emitted from the visible light source device 20 is incident on the first dichroic mirror 210. The first dichroic mirror 210 reflects the red light R of the incident white light WL and transmits the green light G and the blue light B. Accordingly, the first dichroic mirror 210 separates the white light WL emitted from the visible light source device 20 into the red light R, and light of the green light G and the blue light B.

The second dichroic mirror 220 is disposed on an extension line of the optical axis AX20 of the visible light source device 20. The second dichroic mirror 220 is disposed on an optical axis AX150 of the invisible light source device 150 in a manner of facing the invisible light source device 150. In the embodiment, the optical axis AX20 of the visible light source device 20 and the optical axis AX150 of the invisible light source device 150 are orthogonal to each other. The second dichroic mirror 220 is provided in a posture inclined by 45° relative to both the optical axis AX20 of the visible light source device 20 and the optical axis AX150 of the invisible light source device 150. The second dichroic mirror 220 has a first surface 220a and a second surface 220b. The first surface 220a faces the invisible light source device 150. The second surface 220b faces the visible light source device 20.

The green light G and the blue light B transmitted through the first dichroic mirror 210 are incident on the second surface 220b of the second dichroic mirror 220. The second dichroic mirror 220 reflects the green light G and transmits the blue light B. That is, the second dichroic mirror 220 emits the green light G from the second surface 220b, and emits the blue light B from the first surface 220a. Accordingly, the second dichroic mirror 220 separates the green light G and the blue light B.

The infrared light I emitted from the invisible light source device 150 is incident on the first surface 220a of the second dichroic mirror 220. The second dichroic mirror 220 transmits the incident infrared light I. Therefore, the second dichroic mirror 220 emits the infrared light I from the second surface 220b.

The first reflection mirror 230 and the second reflection mirror 240 are disposed on an optical path of the blue light B. The first reflection mirror 230 and the second reflection mirror 240 reflect substantially all of the incident blue light B. The third reflection mirror 250 is disposed on an optical path of the red light R. The third reflection mirror 250 reflects substantially all of the incident red light R.

The red light R reflected by the first dichroic mirror 210 is reflected by the third reflection mirror 250 and is guided to the second liquid crystal panel 400R. The green light G transmitted through the first dichroic mirror 210 and reflected by the second dichroic mirror 220 is guided to the first liquid crystal panel 400G. The blue light B transmitted through the first dichroic mirror 210 and the second dichroic mirror 220 is reflected by the first reflection mirror 230 and the second reflection mirror 240 and is guided to the third liquid crystal panel 400B. The infrared light I transmitted through the second dichroic mirror 220 is guided to the first liquid crystal panel 400G together with the green light G.

In the embodiment, the green light G and the infrared light I are combined by being both emitted from the second surface 220b of the second dichroic mirror 220. That is, the second dichroic mirror 220 functions as a light combining element. Here, combined light of the green light G and the infrared light I combined by the second dichroic mirror 220 is referred to as first combined light C1. The second dichroic mirror (first light combining element) 220 forms the first combined light C1 by combining the green light G and the infrared light I.

In the embodiment, the second dichroic mirror 220 is preferably provided with a film that cancels out polarized light on the first surface 220a and the second surface 220b. A typical dichroic mirror imparts polarization to light that passes through the dichroic mirror. According to the second dichroic mirror 220 in the embodiment, even when the infrared light I is transmitted through the second dichroic mirror 220, polarized light can be canceled out when the polarized light passes through the first surface 220a and then passes through the second surface 220b. Therefore, even after the infrared light I is transmitted through the second dichroic mirror 220, a non-polarizing state of the infrared light I can be maintained.

Films provided on the first surface 220a and the second surface 220b are optical thin films. The film provided on the first surface 220a transmits the infrared light I. The film provided on the second surface 220b reflects the green light G and transmits the infrared light I. In the second dichroic mirror 220 according to the embodiment, transmittance of the films on the first surface 220a and the second surface 220b for the infrared light I incident at an incident angle of 30° or more and 60° or less is 90% or more. In the second dichroic mirror 220 according to the embodiment, for S-polarized light and P-polarized light of the infrared light I, polarized light having a larger difference between a maximum transmittance and a minimum transmittance when the infrared light I is incident on the second dichroic mirror 220 at an incident angle of 30° or more and 60° or less is, for example, the S-polarized light (first polarized light). For the films on the first surface 220a and the second surface 220b, the transmittance changes depending on an incident angle of the infrared light I. Here, when the transmittance of the infrared light I increases corresponding to an increase on an incident side, it is assumed that “inclination of incident angle dependency is positive”. On the other hand, when the transmittance of the infrared light I decreases corresponding to an increase on the incident side, it is assumed that “inclination of the incident angle dependency is negative”. The second dichroic mirror 220 according to the embodiment has a range of incident angles in which the inclination of the incident angle dependency of the transmittance of S-polarized light of the infrared light I on the film of the second surface 220b and the inclination of the incident angle dependency of the transmittance of the S-polarized light of the infrared light I on the film of the first surface 220a are opposite to each other. The range is, for example, 40° to 55° and includes 45°. In the second dichroic mirror 220 according to the embodiment, as described above, the range of the incident angles in which the positive and negative of the inclination of the incident angle dependency of the transmittance of the S-polarized light of the infrared light I on the film of the second surface 220b is opposite to the positive and negative of the inclination of the incident angle dependency of the transmittance of the S-polarized light of the infrared light I on the film of the first surface 220a, and polarization compensation is performed for the film of the first surface 220a.

### Field Lens

The field lenses 300R, 300G, and 300B are disposed between the color separation optical system 200 and the respective liquid crystal panels 400R, 400G, and 400B on the respective optical paths of the red light R, the green light G, and the blue light B. The red light R is transmitted through the field lens 300R and is incident on an image forming region of the second liquid crystal panel 400R. The green light G reflected by the second dichroic mirror 220 is transmitted through the field lens 300G and is incident on an image forming region of the first liquid crystal panel 400G. The blue light B reflected by the third reflection mirror 250 is transmitted through the field lens 300B and is incident on an image forming region of the third liquid crystal panel 400B.

### Light Transmitting Member

The light transmitting member 505 is disposed on a light incident surface side of the first liquid crystal panel 400G. The light transmitting member 505 according to the embodiment is disposed between the field lens 300G and the first liquid crystal panel 400G. The light transmitting member 505 may be disposed on the optical path of the first combined light C1 and between the second dichroic mirror 220 and the first emission-side polarizing plate 420.

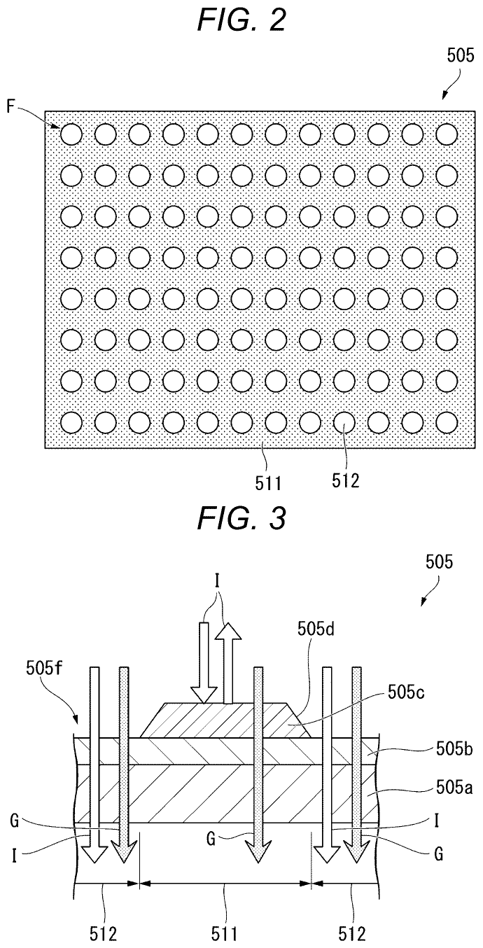

FIG. 2 is a schematic plan view showing the light transmitting member 505 according to the embodiment. The light transmitting member 505 includes a shielding portion 511 and transmission portions 512. The shielding portion 511 shields the infrared light I by reflecting or absorbing the infrared light I, and transmits visible light (particularly, the green light G in the embodiment). On the other hand, the transmission portions 512 transmit both the infrared light I and the visible light. In the embodiment, the transmission portions 512 are arranged in a predetermined pattern F. In the embodiment, the predetermined pattern F of the transmission portions 512 is a dot-shaped pattern. Therefore, the infrared light I that passed through the light transmitting member 505 includes a predetermined dot-shaped pattern F. On the other hand, the visible light that passed through the light transmitting member 505 is not shielded by the light transmitting member 505, and the pattern F does not change before and after the visible light passes through the light transmitting member 505.

FIG. 3 is a schematic cross-sectional view showing the light transmitting member 505 according to the embodiment.

The light transmitting member 505 according to the embodiment has a plate shape and has an incident surface 505f on which the green light G and the infrared light I are incident. The light transmitting member 505 according to the embodiment includes a base material 505a, an antireflection film 505b, and a shielding film 505c.

The base material 505a is made of, for example, quartz glass. The base material 505a transmits both visible light and infrared light. The antireflection film 505b is formed on the entire surface of the base material 505a on a side close to the incident surface 505f. The antireflection film 505b prevents light incident from a surface from being reflected.

The shielding film 505c is formed on a part of the antireflection film 505b on the base material 505a on a side close to the incident surface 505f. The shielding film 505c according to the embodiment is an infrared light reflecting film. Therefore, the shielding film 505c reflects the infrared light I and transmits visible light (particularly, the green light G in the embodiment). The shielding film 505c may shield the infrared light I by absorbing the infrared light I. That is, the shielding film 505c may be any film that shields the infrared light I and transmits the visible light.

In the light transmitting member 505 according to the embodiment, a region where the shielding film 505c is formed functions as the shielding portion 511, and the other regions function as the transmission portions 512. Therefore, in the light transmitting member 505 according to the embodiment, the region where the shielding film 505c is not formed forms the predetermined dot-shaped pattern F.

In a method for manufacturing the light transmitting member 505, first, the antireflection film 505b is vapor-deposited on a surface of the base material 505a on the side close to the incident surface 505f. Next, the shielding film 505c is formed by a metal mask method. In the metal mask method, the shielding film 505c is vapor-deposited on the surface of the antireflection film 505b through a metal mask in which holes corresponding to the predetermined pattern Fare formed. When the metal mask method is adopted as a method for forming the shielding film 505c, the shielding film 505c may be vapor-deposited only on a portion other than the predetermined pattern F. The metal mask method is advantageous in that accuracy of the metal mask is easily increased and productivity of a metal mask is high.

The shielding film 505c may be formed by a lift-off method. In the lift-off method, first, a resist is applied to the surface of the antireflection film 505b, exposure and development are performed using a photomask in accordance with the predetermined pattern F, and the shielding film 505c is vapor-deposited on the remaining resist. Finally, only the shielding film 505c formed directly on the antireflection film 505b remains by removing the remaining resist.

### Liquid Crystal Panel

The liquid crystal panels 400R, 400G, and 400B respectively modulate the incident red light R, green light G, and blue light B according to image information to form an image. An operation mode of the liquid crystal panel may be any one of a TN mode, a VA mode, a lateral electric field mode, and the like, and is not limited to a specific mode.

The first combined light C1 (that is, the green light G and the infrared light I) is incident on the first liquid crystal panel 400G. The first liquid crystal panel 400G modulates the first combined light C1. The first liquid crystal panel 400G modulates at least the green light G contained in the first combined light C1. The red light R is incident on the second liquid crystal panel 400R. The second liquid crystal panel 400R modulates the red light R. The blue light B is incident on the third liquid crystal panel 400B. The third liquid crystal panel 400B modulates the blue light B. In the embodiment, the liquid crystal panels 400R, 400G, and 400B modulate P-polarized light into S-polarized light in an OFF region. On the other hand, P-polarized light is transmitted (as P-polarized light) in an ON region.

### Polarizing Plate

The first incident-side polarizing plate 410G is disposed on a light incident surface side of the first liquid crystal panel 400G. The first incident-side polarizing plate 410G may be disposed on the optical path of the green light G and between the visible light source device 20 and the second dichroic mirror 220. The first incident-side polarizing plate 410G transmits the green light G and the blue light B on the light incident side of the first liquid crystal panel 400G. The first incident-side polarizing plate 410G P-polarizes the green light G that was P-polarized by the polarization conversion element 92 and then has polarization disturbed on the optical path.

The first emission-side polarizing plate 420G is disposed on a light emitting surface side of the first liquid crystal panel 400G. The first emission-side polarizing plate 420G may be disposed on the optical path of the first combined light C1 and between the first liquid crystal panel 400G and the cross dichroic prism 500. The first emission-side polarizing plate 420G transmits the first combined light C1 on the light emission side of the first liquid crystal panel 400G. The first emission-side polarizing plate 420G transmits the S-polarized green light G and restricts transmission of the P-polarized green light G.

The second incident-side polarizing plate 410R is disposed on a light incident surface side of the second liquid crystal panel 400R. The second incident-side polarizing plate 410R may be disposed on an optical path of the red light R and between the first dichroic mirror 210 and the second liquid crystal panel 400R. The second incident-side polarizing plate 410R transmits the red light R on the light incident side of the second liquid crystal panel 400R. The second incident-side polarizing plate 410R P-polarizes the red light R that was P-polarized by the polarization conversion element 92 and then has polarization disturbed on the optical path. That is, the second incident-side polarizing plate 410R transmits the P-polarized red light R and restricts transmission of the S-polarized red light R.

The second emission-side polarizing plate 420R is disposed on a light emitting surface side of the second liquid crystal panel 400R. The second emission-side polarizing plate 420R may be disposed on the optical path of the red light R and between the second liquid crystal panel 400R and the cross dichroic prism 500. The second emission-side polarizing plate 420R transmits the red light R on the light emission side of the second liquid crystal panel 400R. The second emission-side polarizing plate 420R transmits the S-polarized red light R and restricts transmission of the P-polarized red light R.

The third incident-side polarizing plate 410B is disposed on a light incident surface side of the third liquid crystal panel 400B. The third incident-side polarizing plate 410B may be disposed on the optical path of the blue light B and between the first dichroic mirror 210 and the third liquid crystal panel 400B. The third incident-side polarizing plate 410B transmits the blue light B on the light incident side of the third liquid crystal panel 400B. The third incident-side polarizing plate 410B P-polarizes the blue light B that was P-polarized by the polarization conversion element 92 and then has polarization disturbed on the optical path. That is, the third incident-side polarizing plate 410B transmits the P-polarized blue light B and restricts transmission of the S-polarized blue light B.

In the embodiment, the first incident-side polarizing plate 410G is disposed on the optical path of the blue light B. Therefore, the blue light B is transmitted through the first incident-side polarizing plate 410G and is P-polarized. However, in the embodiment, the blue light B is repeatedly reflected by a plurality of reflection mirrors 230 and 240 on a path from the first incident-side polarizing plate 410G to the third liquid crystal panel 400G, and thus disturbance of polarization may occur. Therefore, according to the embodiment, the third incident-side polarizing plate 410B is disposed between the reflection mirror 240 and the third liquid crystal panel 400B, and the blue light B is transmitted through the third incident-side polarizing plate 410B, so that the polarization of the blue light B can be adjusted. Accordingly, the blue light B can be P-polarized with little disturbance and then can be incident on the third liquid crystal panel 400B.

The third emission-side polarizing plate 420B is disposed on a light emitting surface side of the third liquid crystal panel 400B. The third emission-side polarizing plate 420B may be disposed on the optical path of the blue light B and between the third liquid crystal panel 400B and the cross dichroic prism 500. The third emission-side polarizing plate 420B transmits the blue light B on the light emission side of the third liquid crystal panel 400B. The third emission-side polarizing plate 420B transmits the S-polarized blue light B and restricts transmission of the P-polarized blue light B.

In the embodiment, the first incident-side polarizing plate 410G, the first emission-side polarizing plate 420G, the second incident-side polarizing plate 410R, the second emission-side polarizing plate 420R, the third incident-side polarizing plate 410B, and the third emission-side polarizing plate 420B are inorganic polarizing plates such as wire grid polarizing plates.

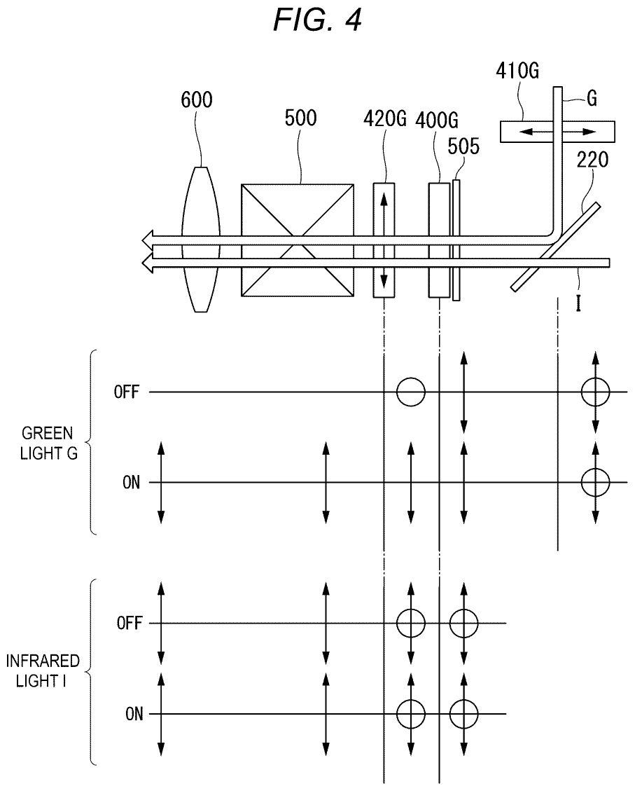

FIG. 4 is a conceptual diagram showing a polarizing state of the first combined light C1 before and after the first liquid crystal panel 400G. Polarizing states of the green light G and the infrared light I are represented by arrows and circles. Arrows represent P-polarized light, and circles represent S-polarized light. A region where an arrow and a circle overlap refers to a state in which both the P-polarized light and the S-polarized light are contained.

As shown in FIG. 4, the green light G passes through the first incident-side polarizing plate 410G before being incident on the second dichroic mirror 220. The second dichroic mirror 220 shields the S-polarized green light G and transmits the P-polarized green light G. The p-polarized light of the green light G emitted from the first incident-side polarizing plate 410G is reflected by the second dichroic mirror 220 and combined with the infrared light I to form the first combined light C1. Further, the green light G contained in the first combined light C1 is transmitted through the light transmitting member 505 and is further incident on the first liquid crystal panel 400G. The first liquid crystal panel 400G modulates the P-polarized green light G into S-polarized light in an OFF region, and transmits the P-polarized green light G in an ON region. When the green light G emitted from the first liquid crystal panel 400G passes through the first emission-side polarizing plate 420G, the S-polarized light is shielded and only the P-polarized light is transmitted. Accordingly, only light transmitted through the ON region of the first liquid crystal panel 400G is incident on the cross dichroic prism 500 as image light.

On the other hand, the infrared light I is transmitted through the second dichroic mirror 220, and is combined with the green light G to form the first combined light C1. Further, when the infrared light I contained in the first combined light C1 is transmitted through the light transmitting member 505, a part of the light is shielded by the shielding portion 511 of the light transmitting member 505 to form the pattern F, and then is incident on the first liquid crystal panel 400G.

In the infrared light I incident on the ON region of the first liquid crystal panel 400G, the P-polarized light and the S-polarized light are transmitted. In the infrared light I incident on the OFF region of the first liquid crystal panel 400G, the P-polarized light and the S-polarized light are inverted and then transmitted. More specifically, the first liquid crystal panel 400G modulates the P-polarized infrared light I into S-polarized light and modulates the S-polarized infrared light I into P-polarized light in the OFF region. That is, the infrared light I is reversed between the P-polarized light and the S-polarized light before and after passing through the first liquid crystal panel 400G. In the embodiment, since the infrared light I incident on the first liquid crystal panel 400G is in a non-polarizing state, the non-polarizing state is maintained even when the P-polarized light and the S-polarized light are reversed from each other, and the P-polarized light and the S-polarized light are transmitted without changing in appearance. That is, in the infrared light I incident on the first liquid crystal panel 400G, the P-polarized light and the S-polarized light are transmitted in both the ON region and the OFF region and are incident on the first emission-side polarizing plate 420G.

That is, since the infrared light I incident on the first liquid crystal panel 400G is in the non-polarizing state, the P-polarized light and the S-polarized light are transmitted in both the ON region and the OFF region and are incident on the first emission-side polarizing plate 420G. Since the S-polarized light of the infrared light I transmitted through the first emission-side polarizing plate 420G is shielded and only the P-polarized light is transmitted, a light amount on an irradiation surface is uniformly reduced to approximately half. Accordingly, the infrared light I that passed through either the ON region or the OFF region of the first liquid crystal panel 400G can also be incident on the cross dichroic prism 500. Therefore, the pattern F of the infrared light I formed in the light transmitting member 505 is not affected by the first liquid crystal panel 400G, and the infrared light I that forms the pattern F can be directly incident on the cross dichroic prism 500.

### Cross Dichroic Prism

As shown in FIG. 1, the cross dichroic prism 500 combines image light emitted from the liquid crystal panels 400R, 400G, and 400B to form a color image. The cross dichroic prism 500 according to the embodiment combines the first combined light C1 emitted from the first liquid crystal panel 400G, the red light R emitted from the second liquid crystal panel 400R, and the blue light B emitted from the third liquid crystal panel 400B into second combined light C2. The second combined light C2 combined by the cross dichroic prism 500 includes the infrared light I in addition to the red light R, the green light G, and the blue light B.

The cross dichroic prism 500 is formed in a substantially cubic shape as a whole, and is disposed such that apex angles of four right angle prisms overlap with a common center position in a side view. In the cross dichroic prism 500, a dielectric multilayer film (not shown) is formed at an interface where the right angle prisms are bonded to one another. The interface described above is formed in a substantially X shape in a side view.

### Projection Optical System

The projection optical system 600 faces the screen SCR. The projection optical system 600 enlarges and projects an image formed by the second combined light emitted from the cross dichroic prism 500 to form the projection images P and Px on the screen SCR. Although not shown, the projection optical system 600 includes a plurality of lenses.

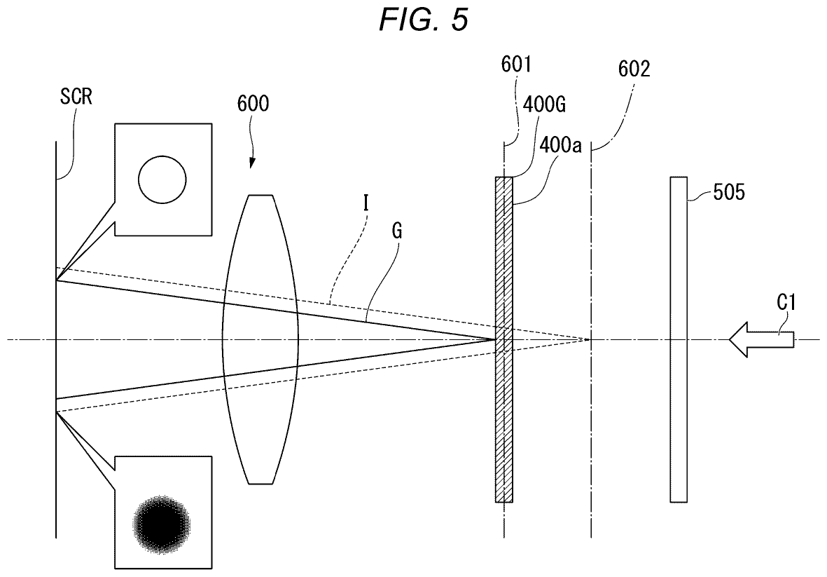

FIG. 5 is a schematic view showing a positional relation among the projection optical system 600, the first liquid crystal panel 400G, and the light transmitting member 505. In FIG. 5, the cross dichroic prism 500 and the first emission-side polarizing plate 420G disposed between the projection optical system 600 and the first liquid crystal panel 400G are not shown.

The projection optical system 600 forms image forming surfaces 601 and 602 on a side opposite to a projection direction. In the following description, an image forming surface of the projection optical system 600 by the green light G is referred to as a green light image forming surface 601, and an image forming surface of the projection optical system 600 by the infrared light I is referred to as an infrared light image forming surface 602.

Optical path lengths from the projection optical system 600 to the image forming surfaces 601 and 602 differ for each wavelength due to an influence of chromatic aberration of the projection optical system 600. Therefore, the green light image forming surface 601 and the infrared light image forming surface 602 are disposed in a manner of deviating from each other on an optical path of the first combined light C1.

The green light image forming surface 601 overlaps the first liquid crystal panel 400G. More specifically, the image forming surface 601 overlaps a liquid crystal panel body 400a of the first liquid crystal panel 400G. Accordingly, an image of the green light G formed by the first liquid crystal panel 400G is clearly projected on the screen SCR through the projection optical system 600.

On the other hand, the infrared light image forming surface 602 is deviated from the light transmitting member 505 in an axial direction of the optical path of the first combined light C1. The infrared light image forming surface 602 according to the embodiment is deviated from the light transmitting member 505 to a side where the first liquid crystal panel 400G is disposed.

Since the infrared light image forming surface 602 is deviated from the light transmitting member 505, an image of the pattern F of the infrared light I formed by being transmitted through the light transmitting member 505 is not focused on the screen SCR. Therefore, when the dot-shaped pattern F is formed by the light transmitting member 505, an image projected on the screen SCR shape by the projection optical system 600 is an image having an illuminance distribution close to a Gaussian distribution in which illuminance gradually decreases from a dot center toward the outside.

As shown in FIG. 1, the pattern F of the infrared light I projected on the screen SCR is imaged by the imaging device 710 and is used for image alignment in the control unit 730. Here, the pattern F of the infrared light I imaged by the imaging device 710 preferably has a Gaussian distribution on the screen SCR. In this case, a position of image light can be recognized with high accuracy by detecting the centroid of the dot-shaped pattern F. In the embodiment, since the projector 15 forms the pattern F of the infrared light I having an illuminance distribution close to the Gaussian distribution on the screen SCR, the imaging device 710 can identify the pattern F of the infrared light I with high accuracy, and highly accurate alignment can be performed.

As shown in FIG. 5, the light transmitting member 505 according to the embodiment is deviated from the infrared light image forming surface 602 to a side opposite to the first liquid crystal panel 400G in an axial direction of an optical axis. Accordingly, the first liquid crystal panel 400G is not disposed between the light transmitting member 505 and the image forming surface 602. According to the embodiment, it is possible to design a distance between the light transmitting member 505 and the infrared light image forming surface 602 without worrying about interference with the first liquid crystal panel 400G, and it is possible to form an image of the infrared light I having a more preferable illuminance distribution on the screen SCR.

Although not shown in FIG. 5, the projection optical system 600 forms image forming surfaces of the red light R and the blue light B on respective optical paths of the red light R and the blue light B. The image forming surface of the red light R overlaps the liquid crystal panel body 400a of the second liquid crystal panel 400R. Similarly, the image forming surface of the blue light B overlaps the liquid crystal panel body 400a of the third liquid crystal panel 400B. Accordingly, the projection image P formed by the first liquid crystal panel 400G, the second liquid crystal panel 400R, and the third liquid crystal panel 400B is clearly projected onto the screen SCR through the projection optical system 600.

### Movement Mechanism

The movement mechanism 720 is connected to the control unit 730. The movement mechanism 720 receives an electric signal from the control unit 730 and moves the projection optical system 600. Accordingly, the control unit 730 changes a position of a projection image on the screen SCR.

### Control Unit

The control unit 730 is implemented by, for example, a computer or an integrated circuit in which processing of the imaging device 710, the movement mechanism 720, the invisible light source device 150, and drive devices that respectively drive the liquid crystal panels 400R, 400G, and 400B are incorporated as programs. The control unit 730 is, for example, a processor. The control unit 730 is connected to the imaging device 710, the movement mechanism 720, and the liquid crystal panels 400R, 400G, and 400B in a wired or wireless manner (not shown).

An image on the screen SCR may change over time due to an influence of heat generated in the projection optical system 600, the cross dichroic prism 500, and the liquid crystal panels 400R, 400G, and 400B. The control unit 730 estimates a positional deviation of an image of the visible light on the screen SCR based on an imaging result of the pattern F of the infrared light I on the screen SCR. Further, the control unit 730 performs control for correcting the positional deviation between images of the infrared light and the visible light on the screen SCR based on an estimation result.

In the embodiment, the control unit 730 can control the movement mechanism 720 based on an image imaged by the imaging device 710. The control unit 730 operates the movement mechanism 720 based on an estimation result of a position of the projection image P of the visible light, and moves the projection optical system 600 in a direction of correcting positional deviation of an image of the visible light.

Further, the control unit 730 may change a region of an image formed in an image display region of each of the liquid crystal panels 400R, 400G, and 400B based on an image imaged by the imaging device 710. In this case, based on the estimation result of the position of the image of the visible light, the control unit 730 causes the liquid crystal panels 400R, 400G, and 400B to form images in which the positional deviation of the image of the visible light is corrected, and corrects the positional deviation of the image on the screen SCR.

### Summary of Embodiment

The projector 15 according to the embodiment described above includes the visible light source device 20, the invisible light source device 150, the second dichroic mirror 220 serving as the first light combining element, the first liquid crystal panel 400G, the first incident-side polarizing plate 410G, the first emission-side polarizing plate 420G, and the projection optical system 600. The visible light source device 20 emits the visible light containing the green light G serving as the first light having a first wavelength. The invisible light source device 150 emits the infrared light I serving as invisible light. The second dichroic mirror 220 combines the green light G and the infrared light I into first combined light C1. The first liquid crystal panel 400G modulates the first combined light C1. The first incident-side polarizing plate 410G transmits the green light G between the visible light source device 20 and the second dichroic mirror 220. The first emission-side polarizing plate 420G transmits the first combined light C1 on the light emission side of the first liquid crystal panel 400G. The projection optical system 600 projects the first combined light C1 emitted from the first liquid crystal panel 400G.

The projector 15 according to the embodiment includes the invisible light source device 150 that emits the infrared light I which is the invisible light, separately from the visible light source device 20 for forming a projection image. In the projector 15 according to the embodiment, the optical path of the infrared light I emitted from the invisible light source device 150 overlaps the optical path of the green light G which is the visible light. In the projector 15 according to the embodiment, the green light G and the infrared light I whose optical paths overlap each other pass through the common first liquid crystal panel 400G as the first combined light C1 and are projected from the projection optical system 600. Therefore, in the projector 15 according to the embodiment, it is possible to directly track movement or deviation of the projection image P due to a factor on the optical path of the visible light (the green light G) by using the invisible light (the infrared light I). In the projector 15 according to the embodiment, a movement amount of the projection image P formed by the green light G coincides with a movement amount detected from the projection image Px formed by the infrared light I, and adjustment of the projection image can be accurately performed based on the movement amounts. As in the embodiment, when the visible light (the green light G) and the invisible light (the infrared light I) are incident on the common first liquid crystal panel 400G, it is desired to prevent the invisible light from being affected by the modulation of the first liquid crystal panel 400G. According to the embodiment, since the first incident-side polarizing plate 410G is disposed between the visible light source device 20 and the second dichroic mirror 220, the first incident-side polarizing plate 410G can be disposed avoiding the optical path of the infrared light I. Therefore, the first incident-side polarizing plate 410G can polarize the green light G that is not combined with the infrared light I. Accordingly, the infrared light I contained in the first combined light C1 that is incident on the first liquid crystal panel 400G can be maintained in a non-polarizing state. As a result, the infrared light I is not affected by the modulation in the first liquid crystal panel 400G, and the infrared light I can be sufficiently projected forward from the projection optical system 600.

In the embodiment, the three-panel projector 15 including the liquid crystal panels 400R, 400G, and 400B that respectively modulate the red light R, the green light G, and the blue light B was described. Alternatively, the configuration described above may be adopted in a single-plate projector that projects monochromatic light onto the screen SCR. In the single-plate projector, the white light WL is used as the first light. Therefore, the first wavelength of the first light in this case is a wavelength of the visible light (360 nm or more and 830 nm or less).

The projector 15 according to the embodiment includes the color separation optical system 200, the second liquid crystal panel 400R, the third liquid crystal panel 400B, the second incident-side polarizing plate 410R, the second emission-side polarizing plate 420R, the third incident-side polarizing plate 410B, the third emission-side polarizing plate 420B, and the cross dichroic prism 500 serving as the second light combining element. The color separation optical system 200 separates the visible light emitted from the visible light source device 20 into the green light G serving as the first light, the red light R serving as the second light, and the blue light B serving as the third light. The second liquid crystal panel 400R modulates the red light R. The third liquid crystal panel 400B modulates the blue light B. The second incident-side polarizing plate 410R transmits the red light R on the light incident side of the second liquid crystal panel 400R. The second emission-side polarizing plate 420R transmits the red light R on the light emission side of the second liquid crystal panel 400R. The third incident-side polarizing plate 410B transmits the blue light B on the light incident side of the third liquid crystal panel 400B. The third emission-side polarizing plate 420B transmits the blue light B on the light emission side of the third liquid crystal panel 400B. The cross dichroic prism 500 combines the first combined light C1 emitted from the first liquid crystal panel 400G, the red light R emitted from the second liquid crystal panel 400R, and the blue light B emitted from the third liquid crystal panel 400B into the second combined light C2. The projection optical system 600 projects the second combined light C2 emitted from the cross dichroic prism 500. According to the projector 15 in the embodiment, it is possible to project light containing the infrared light I forward in a projector that emits image light of two or more colors. In the projector 15 that emits image light of two or more colors, deformation and movement of a projection image due to over-time deformation of components such as the projection optical system 600, the cross dichroic prism 500, and the liquid crystal panels 400R, 400G, and 400B caused by internal heat generation are likely to become significant. According to the embodiment, in the projector 15 that emits image light of three or more colors, a position of an image can be corrected by the infrared light I, and an effect of position correction can be made more significant.

In the projector 15 according to the embodiment, the first light to be combined with the infrared light I to form the first combined light C1 is the green light G. The green light G has highest visibility among light of the three primary colors. In the projector 15 according to the embodiment, the optical path of the infrared light I can be disposed overlapping the optical path of the green light G, and movement and positional deviation of a member on the optical path of the green light G can be directly tracked by the infrared light I. Therefore, it is possible to accurately correct a position of an image of the green light G having high visibility, and a viewer is less likely to feel positional deviation of the image.

In the projector 15 according to the embodiment, the first light combining element that combines the green light G serving as the first light and the infrared light I serving as the invisible light is the dichroic mirror (the second dichroic mirror 220). The number of the dichroic mirror, which transmits or reflects the infrared light I between the invisible light source device 150 and the first liquid crystal panel 400G, is one. In general, it is known that an amount of light transmitted through or reflected by a dichroic mirror is reduced or polarized every time the light is transmitted through or reflected by the dichroic mirror according to the transmittance or reflectance of the dichroic mirror. When polarized light is generated in the infrared light I, the infrared light I is affected by the modulation in the first liquid crystal panel 400G, and a light amount may partially decrease in the projection image Px. According to the projector 15 in the embodiment, an optical element that transmits light from the invisible light source device 150 to the first liquid crystal panel 400G can be minimized, and a decrease in the amount of the infrared light I projected from the projection optical system 600 can be prevented.

In the projector 15 according to the embodiment, the invisible light source device 150 includes the light emitting diode light source 150a that emits the infrared light I serving as the invisible light. The light emitting diode light source 150a can emit light in a non-polarizing state. In the projector 15 according to the embodiment, the infrared light I in a non-polarizing state from the invisible light source device 150 can be incident on the first liquid crystal panel 400G. Therefore, it is possible to prevent the infrared light I from being affected by the modulation of the first liquid crystal panel 400G, and it is easy to improve recognition accuracy of the infrared light I projected on the screen SCR.

In the projector 15 according to the embodiment, the second dichroic mirror 220 serving as the first light combining element has the first surface 220a on which the infrared light I serving as the invisible light is incident and the second surface 220b on which the green light G serving as the visible light is incident. The second dichroic mirror 220 is provided with a film that cancels out polarized light on the first surface 220a and the second surface 220b. According to the projector 15 in the embodiment, when the infrared light I is transmitted through the second dichroic mirror 220, polarized light on the first surface 220a side and the second surface 220b side is canceled out. That is, the second dichroic mirror 220 according to the embodiment easily maintains the non-polarizing state of the transmitted infrared light I. Therefore, it is possible to prevent the infrared light I from being affected by the modulation of the first liquid crystal panel 400G, and it is easy to improve recognition accuracy of the infrared light I projected on the screen SCR.

In the projector 15 according to the embodiment, the invisible light source device 150 emits the infrared light I having a wavelength of 930 nm or more and 950 nm or less. In the projector 15 according to the embodiment, since the light having the wavelength of 930 nm or more and 950 nm or less, which has low solar energy, is used as the infrared light I, it is possible to prevent a decrease in contrast of the pattern F of the infrared light I due to the influence of sunlight when the infrared light I is projected on the screen SCR. As a result, it is possible to prevent a decrease in accuracy of position detection using the pattern F of the infrared light I.

In the projector 15 according to the embodiment, the invisible light source device 150 emits the infrared light I having a wavelength of 840 nm or more and 860 nm or less. In a general light source, light closer to visible light can be emitted with higher efficiency. In the projector 15 according to the embodiment, since the light having the wavelength of 840 nm or more and 860 nm or less is used as the infrared light I, energy efficiency in the invisible light source device 150 can be increased, and low power consumption of the projector 15 can be achieved. Further, since a light source that emits the infrared light I having a wavelength of 840 nm or more and 860 nm or less is widely used as a light source of invisible light, it is possible to stably procure parts at low cost, and it is possible to reduce manufacturing costs of the projector 15.

The projector 15 according to the embodiment includes the light transmitting member 505 disposed between the second dichroic mirror 220 and the first emission-side polarizing plate 420G. The light transmitting member 505 includes the shielding portion 511 and a plurality of the transmission portions 512. The shielding portion 511 shields the infrared light I serving as the invisible light and transmits the green light G serving as the first light, both of which are contained in the first combined light C1. The transmission portions 512 transmit both the infrared light I serving as the invisible light and the green light G serving as the first light, both of which are contained in the first combined light C1. The transmission portions 512 are arranged in the predetermined pattern F. The infrared light I serving as the invisible light projected by the projection optical system 600 includes the predetermined pattern F. In the projector 15 according to the embodiment, the invisible light (the infrared light I) having the predetermined pattern F is projected on the screen SCR. Therefore, it is possible to detect a movement amount of the projection image P formed by the visible light with high accuracy by detecting position information or the like of the predetermined pattern F by the imaging device 710.

In the projector 15 according to the embodiment, the light transmitting member 505 includes the base material 505a that transmits light and the shielding film 505c that is formed on one surface side of the base material 505a, shields invisible light, and transmits the green light G serving as the first light. The predetermined pattern F is formed on a region where the shielding film 505c is not formed on the one surface side of the base material 505a. In the projector 15 according to the embodiment, since the shielding film 505c that absorbs the infrared light I is fairly small relative to the entire light transmitting member 505, it is easy to prevent a temperature rise of the light transmitting member 505. Accordingly, deterioration of the pattern F due to thermal strain or the like of the light transmitting member 505 is less likely to occur, and high accuracy of position detection is easily maintained.

In the projector 15 according to the embodiment, the invisible light source device 150 includes the light source 150a that emits the infrared light I serving as the invisible light and the condensing lens 153 that transmits the infrared light I serving as the invisible light emitted from the light source 150a and forms a homogenizing irradiation pattern. In the projector 15 according to the embodiment, a light amount of the infrared light I is homogenized by being transmitted through the condensing lens 153. According to the embodiment, the invisible light source device 150 can emit the infrared light I with high homogenization. Accordingly, it is possible to prevent variation in an in-plane light amount caused by the light source 150a in the pattern F of the infrared light I formed by being transmitted through the light transmitting member 505. Accordingly, accuracy of position detection using the pattern F of the infrared light I can be improved. Further, since the infrared light I can be emitted with high homogenization and a simple structure by using the condensing lens 153, it is possible to reduce size and cost of the projector 15.

In the projector 15 according to the embodiment, the image forming surface 601 of the projection optical system 600 formed by the green light G serving as the first light overlaps the first liquid crystal panel 400G. The image forming surface 602 of the projection optical system 600 formed by the infrared light I serving as the invisible light is deviated from the light transmitting member 505 in the axial direction of the optical path of the first combined light C1. In the projector 15 according to the embodiment, an image of the binary pattern F of the infrared light I formed by being transmitted through the light transmitting member 505 is not focused on the screen SCR and becomes an image having an illuminance distribution close to a Gaussian distribution. Therefore, the imaging device 710 can identify the pattern F of the infrared light I with high accuracy, and the projection image P can be aligned with high accuracy.

In the projector 15 according to the embodiment, the image forming surface 602 of the projection optical system 600 formed by the infrared light I serving as the invisible light is deviated from the light transmitting member 505 toward a side where the first liquid crystal panel 400G is disposed. That is, the light transmitting member 505 is deviated to an opposite side of the first liquid crystal panel 400G relative to the infrared light image forming surface 602. In the projector 15 according to the embodiment, the first liquid crystal panel 400G is not disposed between the light transmitting member 505 and the infrared light image forming surface 602. Therefore, it is possible to design a distance between the light transmitting member 505 and the image forming surface 602 regardless of a positional relation with the first liquid crystal panel 400G, and an image of the infrared light I having a more preferable illuminance distribution can be formed on the screen SCR.

In the projector 15 according to the embodiment, the first incident-side polarizing plate 410G is an inorganic polarizing plate. When the visible light (green light G) and the invisible light (infrared light I) are incident on the common first liquid crystal panel 400G, the invisible light can be prevented from being affected by the modulation of the first liquid crystal panel 400G, so that it is possible to dispose an organic polarizing plate on the optical path of the first combined light C1. The organic polarizing plate may change a polarizing state depending on a wavelength. Therefore, by using the organic polarizing plate, only the visible light contained in the first combined light C1 can be polarized, and the invisible light can be maintained in a non-polarizing state. However, since the organic polarizing plate absorbs a part of transmitted light and generates heat, the organic polarizing plate may be carbonized unless precise temperature control is performed. According to the embodiment, since the first incident-side polarizing plate 410G is not disposed on the optical path of the infrared light I, an inorganic polarizing plate that is good in heat resistance can be used as the first incident-side polarizing plate 410G. Therefore, precise temperature control is not required for the first incident-side polarizing plate 410G, and costs of the projector 15 can be reduced. In the embodiment, an inorganic polarizing plate can also be used as polarizing plates other than the first incident-side polarizing plate 410G (the first emission-side polarizing plate 420G, the second incident-side polarizing plate 410R, the second emission-side polarizing plate 420R, the third incident-side polarizing plate 410B, and the third emission-side polarizing plate 420B).

The projection system 16 according to the embodiment includes the projector 15 described above and the imaging device 710 that images the projection image Px of the infrared light I projected from the projector 15. The projector 15 includes the movement mechanism 720 that moves the projection optical system 600 to change a position of the projection image Px, and the control unit 730 that controls the movement mechanism 720 based on the image imaged by the imaging device 710. In the projection system 16 according to the embodiment, it is possible to move the projection optical system 600 to an optimal position with high accuracy by using the control unit 730.

The projection system 16 according to the embodiment includes the projector 15 described above and the imaging device 710 that images the projection image Px of the infrared light I projected from the projector 15. The projector 15 includes the control unit 730 that changes a region of an image formed in an image display region of the first liquid crystal panel 400G based on the image imaged by the imaging device 710. In the projection system 16 according to the embodiment, it is possible to change a region of an image of the first liquid crystal panel 400G and move a projection image to an optimal position by using the control unit 730.

Although a transmissive projector is described in the embodiment, the above-described configuration may be applied to a reflective projector. The term “transmissive” refers to that a liquid crystal panel is of a type that transmits light. The term “reflective” refers to that a liquid crystal panel is of a type that reflects light.

### Modifications

Hereinafter, modifications of the embodiment described above will be described. In description of each modification described below, the same components as those of the embodiment described above are denoted by the same reference numerals, and description thereof will be omitted.

### Modification 1

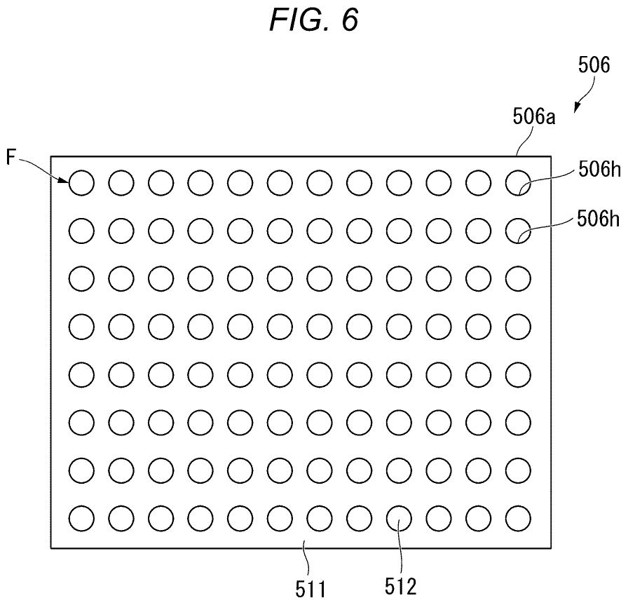

FIG. 6 is a plane schematic view showing a light transmitting member 506 according to a modification. Similar to the embodiment described above, the light transmitting member 506 is disposed on the optical path of the first combined light C1 and between the first incident-side polarizing plate 410G and the first emission-side polarizing plate 420G. Similar to the embodiment described above, the light transmitting member 506 includes the shielding portion 511 and the plurality of transmission portions 512. The shielding portion 511 shields the infrared light I by reflecting the infrared light I and transmits visible light (in particular, the green light G in the modification). On the other hand, the transmission portions 512 transmit both the infrared light I and the visible light. The transmission portions 512 are arranged in the predetermined pattern F (dot-shaped pattern).

The light transmitting member 506 according to the modification includes a shielding plate 506a. The shielding plate 506a shields the infrared light I by reflecting or absorbing the infrared light I. The shielding plate 506a transmits the visible light such as the green light G. The shielding plate 506a is manufactured by forming a shielding film that shields the infrared light I and transmits the visible light such as the green light G on a surface of a base material made of quartz glass. The shielding plate 506a is provided with a plurality of through holes 506h. The through holes 506h constitute the predetermined pattern F for forming the transmission portions 512.

According to the modification, the light transmitting member 506 can be easily manufactured by providing the through holes 506h in the shielding plate 506a that is film-formed on the base material. Therefore, manufacturing costs of the projector 15 can be reduced.

In the light transmitting member 506 according to the modification, when a thickness of the shielding plate 506a is large, reflection of the visible light may occur at an inner edge of the through hole 506h. Therefore, it is preferable that the thickness of the shielding plate 506a is fairly small. More specifically, the shielding plate 506a is preferably 1 mm or less.

### Modification 2

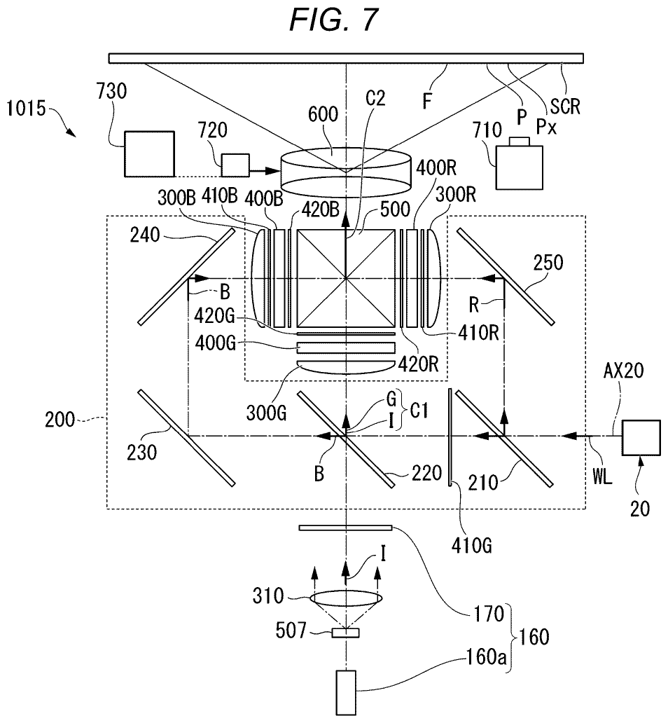

FIG. 7 is a schematic view showing a configuration of a projector 1015 according to Modification 2. The projector 1015 according to the modification is different from the projector according to the embodiment described above in a configuration for forming the predetermined pattern F of the infrared light I and a configuration of an invisible light source device 160.

As compared with the embodiment described above, the projector 1015 according to the modification does not include the light transmitting member 505, and forms the pattern F by a diffractive optical element 507. That is, the projector 1015 according to the modification includes the diffractive optical element 507 and a collimating lens 310 instead of the light transmitting member 505.

In the projector 1015 according to the modification, the diffractive optical element 507 and the collimating lens 310 are disposed on the optical path of the infrared light I and between the invisible light source device 160 and the second dichroic mirror 220. The diffractive optical element 507 diffracts the transmitted infrared light I to form the predetermined pattern F. The predetermined pattern F is determined by a surface pattern of the diffractive optical element 507. The collimating lens 310 collimates the infrared light I emitted from the diffractive optical element 507.

The infrared light I emitted from the diffractive optical element 507 is collimated by the collimating lens 310, and then is transmitted through the second dichroic mirror 220, the field lens 300G, the first incident-side polarizing plate 410G, the first liquid crystal panel 400G, the first emission-side polarizing plate 420G, and the cross dichroic prism 500, and is incident on the projection optical system 600. An image of the predetermined pattern F of the infrared light I formed by the diffractive optical element 507 is formed in the vicinity of the first liquid crystal panel 400G and between the first incident-side polarizing plate 410G and the first emission-side polarizing plate 420G. The infrared light I projected by the projection optical system 600 includes the predetermined pattern F.

In the diffractive optical element 507 according to the modification, the dot-shaped pattern F can be formed by a relatively simple surface pattern. Since the diffractive optical element 507 forms an image of the predetermined pattern F in the air, it is not necessary to dispose a light transmitting member on the optical path of the visible light, and a reduction in a light amount of the visible light can be prevented, as compared with the embodiment described above.

In order to form the predetermined pattern F of the invisible light by the diffractive optical element 507, it is preferable to use coherent light (for example, laser light) as light incident on the diffractive optical element 507. By making coherent light incident on the diffractive optical element 507, the pattern F having a desired shape can be formed by the diffractive optical element 507 without diffusing the light.

The diffractive optical element 507 according to the modification is less likely to transmit visible light. According to the modification, since the diffractive optical element 507 is disposed between the invisible light source device 160 and the second dichroic mirror 220, the diffractive optical element 507 does not prevent transmission of visible light.

The invisible light source device 160 according to the modification includes a laser light source 160a and a depolarizing plate 170 that depolarizes the infrared light I emitted from the laser light source 160a.

The laser light source 160a is more easily compatible with high output than a light emitting diode light source. According to the modification, it is possible to increase a contrast ratio of the projection image Px of the infrared light I projected on the screen SCR, it is possible to increase identifiability by the imaging device 710, and it is possible to increase accuracy of position correction as compared with the embodiment described above. Further, the laser light source 160a is good in energy efficiency as compared with the light emitting diode light source. According to the modification, power saving of the projector 1015 can be achieved.

The depolarizing plate 170 is disposed on the optical path of the infrared light I and transmits the infrared light I. The depolarizing plate 170 depolarizes the transmitted infrared light I. The infrared light I emitted from the laser light source 160a is incident on the depolarizing plate 170. The infrared light I emitted from the laser light source 160a is polarized in a biased manner, and is, for example, in a linearly polarizing state. Since the invisible light source device 160 according to the modification includes the depolarizing plate 170, even when the laser light source 160a is used as a light source, the emitted infrared light I can be made in a non-polarizing state. Therefore, it is possible to prevent the infrared light I from being affected by the modulation of the first liquid crystal panel 400G, and it is easy to improve recognition accuracy of the infrared light I projected on the screen SCR.

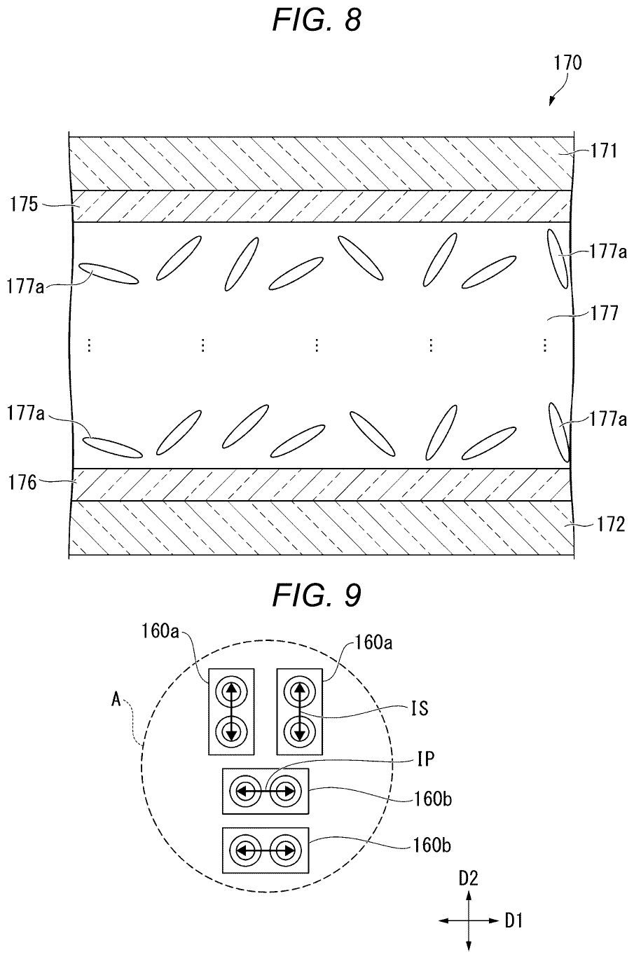

FIG. 8 is a schematic cross-sectional view showing the depolarizing plate 170 according to the modification. The depolarizing plate 170 includes a first substrate 171, a first organic film 175, a liquid crystal layer 177, a second organic film 176, and a second substrate 172. The first substrate 171, the first organic film 175, the liquid crystal layer 177, the second organic film 176, and the second substrate 172 are stacked in this order along a thickness direction of the depolarizing plate 170.

Each of the first substrate 171 and the second substrate 172 is a light transmitting base material made of quartz glass. The first organic film 175 is stacked on the first substrate 171. The second organic film 176 is stacked on the second substrate 172. Each of the first organic film 175 and the second organic film 176 is a polyimide film that was not subjected to rubbing treatment. Therefore, each of the first organic film 175 and the second organic film 176 has no orientation regulating force that regulates orientation directions of liquid crystal molecules. That is, each of the first organic film 175 and the second organic film 176 has no orientation regulating force that orients the liquid crystal molecules in one direction to align orientations of the liquid crystal molecules.

The liquid crystal layer 177 is disposed between the first organic film 175 and the second organic film 176. As described above, each of the first organic film 175 and the second organic film 176 that sandwich the liquid crystal layer 177 has no orientation regulating force. Therefore, a plurality of liquid crystal molecules 177a which constitute the liquid crystal layer 177 have random orientation directions. For example, the plurality of liquid crystal molecules 177a are randomly oriented in a plane orthogonal to the first substrate 171 or the second substrate 172, as described above. That is, the liquid crystal layer 177 contains the liquid crystal molecules arranged with the major axis directions thereof being oriented disorderly relative to the first organic film 175 and the second organic film 176.

According to the depolarizing plate 170 in the modification, the liquid crystal molecules of the liquid crystal layer 177 are arranged in a state in which the major axis directions are randomly oriented. When light is incident on the depolarizing plate 170 having a such configuration, a random phase difference is given to the light passing through the liquid crystal layer 177. Therefore, light emitted from the depolarizing plate 170 can be made in a non-polarizing state.

As described above, the depolarizing plate 170 according to the modification is of a liquid crystal type. The depolarizing plate 170 of the liquid crystal type has a very high depolarization degree. Therefore, it is easy to prevent the infrared light I from being affected by the modulation of the first liquid crystal panel 400G, and it is easy to improve recognition accuracy of the projection image Px of the infrared light I projected on the screen SCR.

In the modification, the depolarizing plate 170 may be omitted by using two laser light sources (the first laser light source 160a and a second laser light source 160b) that emit S-polarized light and P-polarized light. FIG. 9 is a schematic view showing the first laser light source 160a and the second laser light source 160b that can be adopted in the modification, as viewed from an optical axis direction. As shown in FIG. 9, the invisible light source device 160 may include, for example, two first laser light sources 160a and two second laser light sources 160b. The two first laser light sources 160a are disposed along a D1 direction orthogonal to an optical axis of the invisible light source device 160. The first laser light sources 160a emit infrared S-polarized light IS. The two second laser light sources 160b are disposed along a D2 direction orthogonal to the optical axis and the D1 direction. The second laser light sources 160b emit infrared P-polarized light IP. In FIG. 9, vibration directions of the infrared S-polarized light IS and the infrared P-polarized light IP are indicated by arrows. The two first laser light sources 160a and the two second laser light sources 160b are relatively disposed in a light emitting region A of the invisible light source device 160.

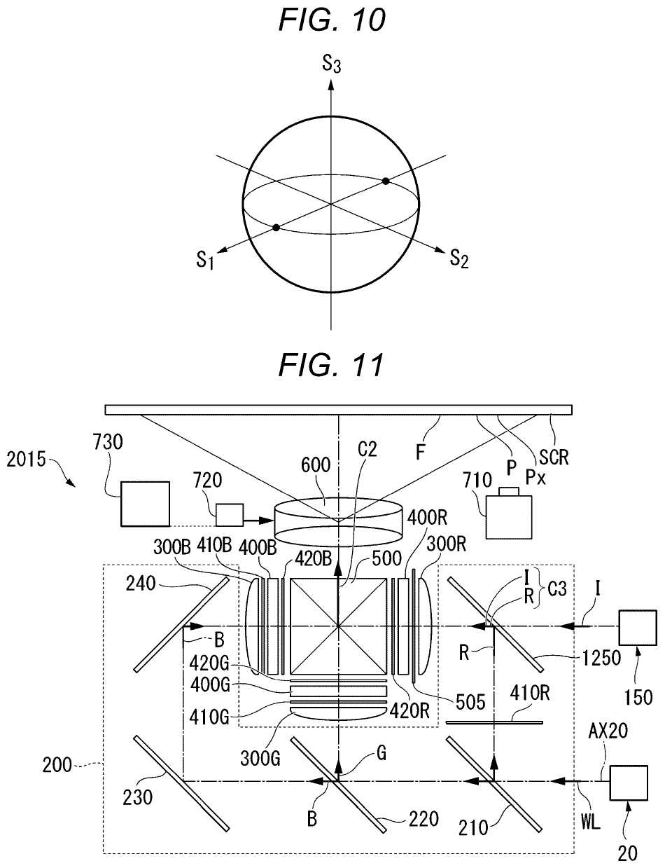

FIG. 10 is a diagram showing a polarizing state of the infrared light I emitted from the laser light sources 160a and 160b using the Poincare sphere. As shown in FIG. 10, plots of the infrared light I emitted from the invisible light source device 160 on the Poincare sphere are symmetric relative to the center.

According to the modification, the first laser light source 160a is disposed along the D1 direction which is a first direction orthogonal to the optical axis of the invisible light source device 160, and emits the infrared S-polarized light IS which is first light in a first polarization direction. The second laser light source 160b is disposed along the D2 direction orthogonal to the optical axis, and emits the infrared P-polarized light IP which is first light in a second polarization direction. According to this configuration, the invisible light source device 160 can emit the infrared light I including the infrared S-polarized light IS and the infrared P-polarized light IP while increasing a light amount of the emitted infrared light I, and the depolarizing plate 170 can be omitted.

### Modification 3

FIG. 11 is a schematic view showing a configuration of a projector 2015 according to Modification 3. The projector 2015 according to the modification is mainly different from the embodiment described above in that the first light sharing an optical path with the infrared light I is the red light R.

The projector 2015 according to the modification includes a third dichroic mirror (first light combining element) 1250 instead of the third reflection mirror 250 in the embodiment described above. The third dichroic mirror 1250 combines the red light R serving as the first light and the infrared light I serving as the invisible light. That is, the third dichroic mirror 1250 transmits the infrared light I and reflects the red light R to combine the infrared light I and the red light R into first combined light C3.

In the modification, the second liquid crystal panel 400R performs the same function as the first liquid crystal panel 400G in the embodiment described above. That is, the second liquid crystal panel 400R modulates the first combined light C3. In the modification, the second incident-side polarizing plate 410R transmits the red light R between the invisible light source device 150 and the third dichroic mirror 1250. The second incident-side polarizing plate 410R transmits the first combined light C3 on a light emission side of the second liquid crystal panel 400R. Further, the light transmitting member 505 is provided on an optical path of the first combined light C3 and between the second incident-side polarizing plate 410R and the second emission-side polarizing plate 420R.

According to the modification, the second incident-side polarizing plate 410R is disposed between the visible light source device 20 and the third dichroic mirror 1250. Therefore, the second incident-side polarizing plate 410R can polarize the red light R that is not combined with the infrared light I. Accordingly, the infrared light I contained in the first combined light C1 that is incident on the second liquid crystal panel 400R can be maintained in a non-polarizing state. As a result, the infrared light I is not affected by the modulation in the second liquid crystal panel 400R, and the infrared light I can be sufficiently projected forward from the projection optical system 600.

In the projector 2015 according to the modification, the invisible light is the infrared light I, and the first light sharing the optical path with the infrared light is the red light R. The red light R has a wavelength closest to the infrared light I among light of the three primary colors for forming a projection image. In the projector 2015 according to the modification, since the infrared light I and the red light R constituting the first combined light C3 have wavelengths close to each other, it is easy to improve reflection performance of a reflection surface that reflects the first combined light C3 in the cross dichroic prism 500. As a result, a light amount of the infrared light I emitted from the cross dichroic prism 500 is easily increased, and recognition accuracy of the projection image Px of the infrared light I projected on the screen SCR is easily increased.

According to the modification, the light transmitting member 505 is not disposed on the optical path of the green light G. Therefore, it is possible to prevent a decrease in a light amount of the green light G having high visibility. Accordingly, it is easy to ensure brightness of the projection image P of the visible light projected from the projector 2015.

### Modification 4

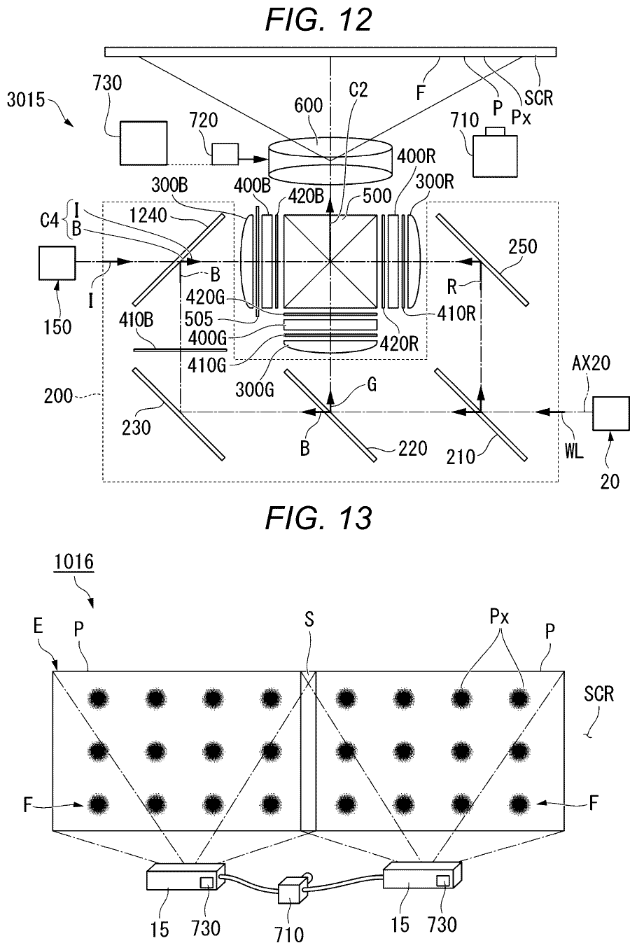

FIG. 12 is a schematic view showing a configuration of a projector 3015 according to Modification 4. The projector 3015 according to the modification is mainly different from the embodiment described above in that the first light sharing an optical path with the infrared light I is the blue light B.

The projector 3015 according to the modification includes a fourth dichroic mirror (first light combining element) 1240 instead of the third reflection mirror 250 in the embodiment described above. The fourth dichroic mirror 1240 combines the blue light B serving as the first light and the infrared light I serving as the invisible light. That is, the fourth dichroic mirror 1240 transmits the infrared light I and reflects the blue light B to combine the infrared light I and the blue light B into first combined light C4.

In the modification, the third liquid crystal panel 400B performs the same function as the first liquid crystal panel 400G in the embodiment described above. That is, the third liquid crystal panel 400B modulates the first combined light C4. In the modification, the third incident-side polarizing plate 410B transmits the blue light B between the invisible light source device 150 and the fourth dichroic mirror 1240. The third incident-side polarizing plate 410B transmits the first combined light C4 on a light emission side of the third liquid crystal panel 400B. Further, the light transmitting member 505 is provided on an optical path of the first combined light C4 and between the third incident-side polarizing plate 410B and the third emission-side polarizing plate 420B.

According to the modification, the third incident-side polarizing plate 410B is disposed between the visible light source device 20 and the fourth dichroic mirror 1240. Therefore, the third incident-side polarizing plate 410B can polarize the blue light B that is not combined with the infrared light I. Accordingly, the infrared light I contained in the first combined light C1 that is incident on the third liquid crystal panel 400B can be maintained in a non-polarizing state. As a result, the infrared light I is not affected by the modulation in the third liquid crystal panel 400B, and the infrared light I can be sufficiently projected forward from the projection optical system 600.

In the modification, the light transmitting member 505 through which the first combined light C4 is transmitted has the same configuration as that in the embodiment described above. That is, as shown in FIG. 3, the light transmitting member 505 includes the shielding film 505c that transmits the visible light and shields the infrared light I by reflecting the infrared light I. An edge portion 505d having a reduced film thickness may be formed on an outer edge of the shielding film 505c. In the shielding film 505c, a function of transmitting the visible light in the edge portion 505d may be low, and a part of the visible light having a wavelength close to the wavelength of the infrared light I may be reflected. In this case, a light amount of the visible light transmitted through the light transmitting member 505 is reduced at an outer edge of the pattern F of the infrared light I.

In the projector 3015 according to the modification, the invisible light is the infrared light I, and the first light sharing an optical path with the infrared light is the blue light B. The blue light B has a wavelength farthest from the infrared light I among light of the three primary colors for forming a projection image. Therefore, the blue light B is less likely to be reflected by the edge portion 505d of the shielding film 505c, and it is possible to prevent a partial decrease in the light amount of the blue light B when the blue light B is transmitted through the light transmitting member 505. Further, the blue light B is light having relatively low visibility among the three primary colors. Therefore, even when a light amount partially decreases in an image of the blue light B due to the influence of the edge portion 505d, a viewer is less likely to recognize the decrease.

According to the modification, the light transmitting member 505 is not disposed on the optical path of the green light G, and it is possible to prevent a decrease in a light amount of the green light G having high visibility. Accordingly, it is possible to ensure brightness of the projection image P of the visible light projected from the projector 3015.

### Modification 5

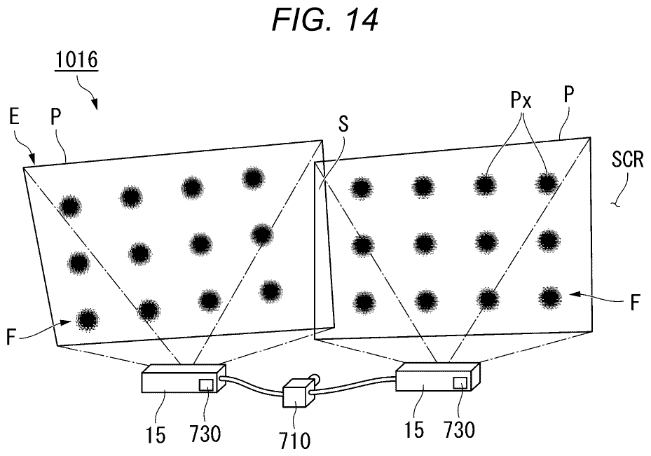

FIGS. 13 and 14 are schematic views showing a projection system 1016 according to a modification using the projector 15 described above. FIG. 13 shows the projection image P in an initial state or after image correction is performed, and FIG. 14 shows the projection image P before image correction is performed.

As shown in FIG. 13, the projection system 1016 according to the modification includes a plurality of (two in the modification) the projectors 15 and one imaging device 710. In the projection system 1016 according to the modification, the projection images P respectively projected from the plurality of projectors 15 toward one screen SCR are arranged in a left and right direction to form one extended image E extended in the left and right direction. The projection image P projected from each of the projectors 15 forms each part of the extended image E. Therefore, the respective projectors 15 cause the respective control units 730 to function in cooperation with one another to generate the projection images P in cooperation with one another.

The projection images P of the plurality of projectors 15 form an overlapping portion S on the screen SCR. The plurality of projection images P overlap one another in the overlapping portion S. By providing the overlapping portion S, the projection system 1016 can form, on the screen SCR, the extended image E having no discontinuities at seam between the projection images P. However, when the projection system 1016 is continuously used, a position of each projection image P changes due to a change in an environmental temperature around the projector 15, a change in an internal temperature caused by internal heat generation, and the like. In general, a position change amount of the projection image P is required to be less than 1.5 pixels. Therefore, as shown in FIG. 14, the overlapping portion S may be deformed, and natural coupling of the plurality of projection images P may be impaired.

In the projection system 1016 according to the modification, the control unit 730 of each of the projectors 15 is coupled to the imaging device 710. The projection image Px of the infrared light I is superimposed on the projection image P of the visible light projected from each of the projectors 15. The imaging device 710 images the projection image Px of the infrared light I with the entire extended image E included in the angle of view. That is, the imaging device 710 simultaneously images the projection images Px of the infrared light I projected from the plurality of projectors 15.

In each of the projectors 15, the control unit 730 corrects a position of the projection image P based on the projection image Px of the infrared light I imaged by the imaging device 710. In the modification, the plurality of control units 730 perform position correction for an image in cooperation with one another. Accordingly, the control unit 730 of each of the projectors 15 adjusts a shape of the overlapping portion S of the projection images P projected from the projectors 15.

In each of the projectors 15, the control unit 730 operates the movement mechanism 720 to move the projection optical system 600 of each projector 15 and corrects a position of the projection image P to adjust a shape and a size of the overlapping portion S. The control unit 730 may adjust the shape of the overlapping portion S by changing a region of an image formed in an image display region of each of the liquid crystal panels 400R, 400G, and 400B of each projector 15 and correcting the position of the projection image P.

In the projection system 1016 according to the modification, it is possible to move the projection optical system 600 to an optimal position with high accuracy by using the control unit 730. Accordingly, the number of pixels of the overlapping portion S in a direction (the left and right direction) in which the projection images P are arranged can be made less than 1.5, and a viewer can recognize the naturally extended image E. Further, even when positions of a plurality of the projection images P change over time due to heat generation or the like, it is possible to correct the changed projection images P and prevent deformation of the overlapping portion S.

In the projection system 1016, the projection images P may be arranged in an up and down direction as one extended image E. The number of projectors 15 constituting the projection system 1016 may be three or more, and in this case, a plurality of projection images P arranged in the up and down and left and right directions may be one extended image E. Further, the number of the imaging devices 710 constituting the projection system 1016 may be two or more.

Although preferred embodiments and modifications of the present disclosure have been described above in detail, the present disclosure is not limited to such specific embodiments and modifications, and various modifications and changes can be made within the scope of the gist of the present disclosure described in the claims. Components of a plurality of embodiments can be combined as appropriate.

### Summary of Present Disclosure

The present disclosure will be summarized below in the form of appendixes.

### Appendix 1

A projector including:
a visible light source device configured to emit visible light containing first light having a first wavelength;
an invisible light source device configured to emit invisible light;
a first light combining element configured to combine the first light and the invisible light into first combined light;
a first liquid crystal panel configured to modulate the first combined light;
a first incident-side polarizing plate configured to transmit the first light between the visible light source device and the first light combining element;
a first emission-side polarizing plate configured to transmit the first combined light at a light emission side of the first liquid crystal panel; and
a projection optical system configured to project the first combined light emitted from the first liquid crystal panel.

According to this configuration, the projector includes the invisible light source device that emits the infrared light which is invisible light separately from the visible light source device for forming the projection image. An optical path of the infrared light emitted from the invisible light source device overlaps an optical path of the visible light. Further, the visible light and the invisible light whose optical paths overlap each other pass through the common first liquid crystal panel as the first combined light and are projected from the projection optical system. Therefore, in the projector, it is possible to use the invisible light to directly track movement or deviation of the projection image due to a factor on the optical path of the visible light. As a result, a movement amount of the projection image formed by the visible light coincides with a movement amount detected from the projection image formed by the invisible light, and the projection image can be accurately adjusted based on the movement amounts. According to the configuration described above, the first incident-side polarizing plate can be disposed between the light source device and the second dichroic mirror in a manner of avoiding an optical path of the visible light. Accordingly, the first incident-side polarizing plate polarizes the first light that is not combined with the invisible light. As a result, a non-polarizing state of the invisible light that is incident on the first liquid crystal panel can be maintained. The invisible light is not affected by the modulation in the first liquid crystal panel, and the invisible light can be sufficiently projected forward from the projection optical system.

### Appendix 2

The projector according to Appendix 1, further including:
a color separation optical system configured to separate the visible light emitted from the visible light source device into the first light, second light having a second wavelength different from the first wavelength, and third light having a third wavelength different from both the first wavelength and the second wavelength;
a second liquid crystal panel configured to modulate the second light;
a third liquid crystal panel configured to modulate the third light;
a second incident-side polarizing plate configured to transmit the second light at a light incident side of the second liquid crystal panel;
a second emission-side polarizing plate configured to transmit the second light at a light emission side of the second liquid crystal panel;
a third incident-side polarizing plate configured to transmit the third light at a light incident side of the third liquid crystal panel;
a third emission-side polarizing plate configured to transmit the third light at a light emission side of the third liquid crystal panel; and
a second light combining element configured to combine the first combined light emitted from the first liquid crystal panel, the second light emitted from the second liquid crystal panel, and the third light emitted from the third liquid crystal panel into second combined light, in which
the projection optical system projects the second combined light emitted from the second light combining element.

According to this configuration, in the projector that emits image light of two or more colors, such as a three-plate projector, it is possible to project light containing invisible light forward. In the projector that emits image light of two or more colors, a viewer is likely to feel deviation of an image due to over-time deformation of a component caused by internal heat generation. According to the configuration described above, in the projector that emits image light of two or more colors, a position of an image can be corrected by the invisible light, and an effect of position correction can be made more significant.

### Appendix 3

The projector according to Appendix 3, in which
the first light is green light.

According to this configuration, the first light to be combined with the invisible light to form the first combined light is the green light. The green light has highest visibility among light of the three primary colors. According to this configuration, the optical path of the invisible light is disposed in a manner of overlapping the optical path of the green light, and movement or positional deviation of a member on the optical path of the green light can be directly tracked by the invisible light. Therefore, it is possible to accurately correct a position of an image of the green light having high visibility, and it is possible to provide the projector that makes it difficult for a viewer to feel positional deviation of the image.

### Appendix 4

The projector according to Appendix 2, in which
the first light is red light, and
the invisible light is infrared light.

According to this configuration, since the visible light and the invisible light constituting the first combined light have wavelengths close to each other, it is easy to improve reflection performance (or transmission performance) of a reflection surface (or transmission surface) that reflects (or transmits) the first combined light in a cross dichroic mirror. As a result, the light amount of the invisible light is easily increased, and recognition accuracy of the projection image of the invisible light projected on the screen is easily increased.

### Appendix 5

The projector according to Appendix 2, in which
the first light is blue light, and
the invisible light is infrared light.

According to this configuration, since the visible light transmitted through a light transmitting member is light having a wavelength far from the invisible light, the visible light is easily transmitted through a shielding portion of the light transmitting member. Therefore, a portion where a light amount decreases is less likely to occur on an irradiation surface of the visible light. Further, the blue light is light having relatively low visibility among the three primary colors. Therefore, even when a portion where a light amount decreases occurs on the irradiation surface of the visible light, a viewer is less likely to recognize the portion.

### Appendix 6

The projector according to any one of Appendixes 1 to 5, in which
the first light combining element is a dichroic mirror, and
the number of the dichroic mirror that transmits or reflects the invisible light between the invisible light source device and the first liquid crystal panel is one.

In general, it is known that an amount of light transmitted through or reflected by a dichroic mirror is reduced every time the light is transmitted through or reflected by the dichroic mirror according to the transmittance or reflectance of the dichroic mirror. According to the configuration described above, it is possible to minimize an optical element that transmits light from the invisible light source device to the first liquid crystal panel, and it is possible to prevent a decrease in an amount of the invisible light projected from the projection optical system.

### Appendix 7

The projector according to any one of Appendixes 1 to 6, in which
the invisible light source device includes a light emitting diode light source configured to emit the invisible light.

In general, the light emitting diode light source can emit light in a non-polarizing state. According to the configuration described above, the invisible light in a non-polarizing state from the invisible light source device can be incident on the first liquid crystal panel. Therefore, the invisible light can be prevented from being affected by the modulation of the first liquid crystal panel, and it is easy to improve recognition accuracy of the invisible light projected on the screen.

### Appendix 8

The projector according to any one of Appendixes 1 to 6, in which
the invisible light source device includes a laser light source configured to emit the invisible light.

In general, the laser light source is more easily compatible with high output than the light emitting diode light source. Therefore, according to the configuration described above, it is possible to increase a contrast ratio of the projection image of the invisible light projected on the screen by the projector, it is possible to increase identifiability by an imaging device, and it is possible to increase accuracy of position correction. Further, since the laser light source is good in energy efficiency as compared with the light emitting diode light source, power saving of the projector can be achieved.

### Appendix 9

The projector according to Appendix 8, in which
the invisible light source device includes a depolarizing plate configured to transmit the invisible light emitted from the laser light source and depolarize the invisible light.

According to this configuration, since the invisible light source device includes the depolarizing plate, even when the laser light source is used as a light source, the emitted invisible light can be made in a non-polarizing state. Therefore, the invisible light can be prevented from being affected by the modulation of the first liquid crystal panel, and it is easy to improve recognition accuracy of the invisible light projected on the screen.

### Appendix 10

The projector according to Appendix 9, in which
the depolarizing plate includes
   a first substrate,
   a second substrate disposed in a manner of facing the first substrate,
   a first organic film stacked on the first substrate and having no orientation regulating force that regulates an orientation direction of a liquid crystal molecule,
   a second organic film stacked on the second substrate and having no orientation regulating force that regulates an orientation direction of a liquid crystal molecule, and
   a liquid crystal layer disposed between the first organic film and the second organic film and containing a liquid crystal molecule disposed with a major axis direction oriented disorderly with respect to the first organic film and the second organic film.

According to this configuration, a depolarizing plate of a liquid crystal type having a high depolarization degree can be used, and polarization of the invisible light emitted from the invisible light source device can be easily prevented.

### Appendix 11

The projector according to any one of Appendixes 1 to 10, in which
the first light combining element is a dichroic mirror that transmits the invisible light and reflects the first light,
the dichroic mirror has a first surface on which the invisible light is incident and a second surface on which the first light is incident, and
the dichroic mirror is provided with a film that cancels out polarized light on the first surface and polarized light on the second surface.

According to this configuration, even when the invisible light is transmitted through the dichroic mirror serving as a first light combining element, a non-polarizing state can be maintained. Therefore, the invisible light can be prevented from being affected by the modulation of the first liquid crystal panel, and it is easy to improve recognition accuracy of the invisible light projected on the screen.

### Appendix 12

The projector according to any one of Appendixes 1 to 11, in which
the invisible light source device emits the infrared light having a wavelength of 930 nm or more and 950 nm or less.

According to this configuration, by using, as the invisible light, the infrared light having a wavelength of 930 nm or more and 950 nm or less in which solar energy is low, it is possible to prevent a decrease in contrast of a pattern of the invisible light due to the influence of sunlight when the screen is irradiated with the invisible light. As a result, it is possible to prevent a decrease in accuracy of position detection by using the pattern of the invisible light.

### Appendix 13

The projector according to any one of Appendixes 1 to 11, in which
the invisible light source device emits the infrared light having a wavelength of 840 nm or more and 860 nm or less.

According to this configuration, by using, as the invisible light, the infrared light having a wavelength of 840 nm or more and 860 nm or less, energy efficiency in the invisible light source device can be increased, and power consumption of the projector can be reduced. Further, since a light source that emits the infrared light having a wavelength of 840 nm or more and 860 nm or less is widely used as a light source of the invisible light, it is possible to stably procure parts at low cost, and it is possible to reduce manufacturing costs of the projector.

### Appendix 14

The projector according to any one of Appendixes 1 to 13, further including:
the light transmitting member disposed between the first light combining element and the first emission-side polarizing plate, in which
the light transmitting member includes
   the shielding portion configured to shield the invisible light contained in the first combined light and transmit the first light, and
   a transmission portion configured to transmit both the invisible light and the first light contained in the first combined light,
the transmission portion is disposed in a predetermined pattern, and
the invisible light projected by the projection optical system includes the predetermined pattern.

According to this configuration, the invisible light of the predetermined pattern is projected on a projection surface such as a screen, and a movement amount of the projection image formed by the actual visible light can be detected with high accuracy by detecting position information or the like of the predetermined pattern.

### Appendix 15

The projector according to Appendix 14, in which
the light transmitting member includes a shielding plate configured to shield the invisible light and transmit the first light, and
the shielding plate is provided with a through hole having the predetermined pattern.

According to this configuration, the light transmitting member can be easily manufactured by providing the through hole in the shielding plate that is film-formed on a base material. Therefore, manufacturing costs of the projector can be reduced.

### Appendix 16

The projector according to Appendix 14 or 15, in which
the invisible light source device includes
   a light source configured to emit the invisible light, and
   a homogenizing optical element configured to transmit the invisible light emitted from the light source and form a homogenizing irradiation pattern.

According to this configuration, a light amount of the invisible light is homogenized by being transmitted through the homogenizing optical element. Accordingly, the invisible light source device can emit the invisible light with high homogenization. Accordingly, it is possible to prevent variation in an in-plane light amount caused by a light source of the invisible light in the pattern of the invisible light formed by being transmitted through the light transmitting member. Accordingly, accuracy of position detection using the pattern of the invisible light can be improved. Further, since the infrared light can be emitted with high homogenization and a simple structure by using the homogenizing optical element, it is possible to reduce size and cost of the projector.

### Appendix 17

The projector according to any one of the Appendixes 14 to 16, in which
an image forming surface by the first light in the projection optical system overlaps the first liquid crystal panel, and
an image forming surface by the invisible light in the projection optical system is deviated from the light transmitting member in an axial direction of an optical path of the first combined light.

According to this configuration, an image of a binary pattern of the invisible light formed by being transmitted through the light transmitting member is not focused on the screen, and becomes an image having an illuminance distribution close to a Gaussian distribution. Therefore, the imaging device can identify the pattern of the invisible light with high accuracy, and the projection image can be aligned with high accuracy.

### Appendix 18

The projector according to Appendix 17, in which
the image forming surface by the invisible light in the projection optical system is deviated from the light transmitting member to a side where the first liquid crystal panel is disposed.

According to this configuration, the light transmitting member is deviated from the image forming surface to a side opposite to the first liquid crystal panel. The first liquid crystal panel is not disposed between the light transmitting member and the image forming surface. Therefore, a distance between the light transmitting member and the image forming surface can be determined regardless of a positional relationship with the first liquid crystal panel, and an image of the invisible light having a more preferable illuminance distribution can be formed on the screen.

### Appendix 19

The projector according to any one of Appendixes 1 to 6 and Appendixes 8 to 10, further including:
a diffractive optical element that is disposed on an optical path of the invisible light and between the invisible light source device and the first light combining element and is configured to diffract the invisible light to form a predetermined pattern, in which
the invisible light projected by the projection optical system includes the predetermined pattern.

According to this configuration, it is possible to form a projection image of the invisible light having a dot-shaped pattern by the diffractive optical element having a relatively simple surface pattern, and it is possible to reduce manufacturing costs of the projector. In addition, since the diffractive optical element forms an image of the predetermined pattern in the air, it is not necessary to dispose the light transmitting member on the optical path of the visible light, and a reduction in the light amount of the visible light can be prevented.

### Appendix 20

The projector according to any one of Appendixes 1 to 19, in which
the first incident-side polarizing plate is an inorganic polarizing plate.

In the projector having this configuration, the first incident-side polarizing plate is not disposed on the optical path of the invisible light. Therefore, there is no need to use an organic polarizing plate that does not polarize the invisible light as the first incident-side polarizing plate, and an inorganic polarizing plate that is good in heat resistance can be used as the first incident-side polarizing plate. Therefore, precise temperature control is not required for the first incident-side polarizing plate, and costs of the projector can be reduced.

### Appendix 21

A projection system including:
the projector according to any one of Appendixes 1 to 20; and
an imaging device configured to image a projection image of the invisible light projected from the projector, in which
the projector includes
   a movement mechanism configured to move the projection optical system to change a position of the projection image, and
a control unit configured to control the movement mechanism based on an image imaged by the imaging device.

According to this configuration, it is possible to move the projection optical system to an optimal position with high accuracy by using the control unit.

### Appendix 22

A projection system including:
the projector according to any one of Appendixes 1 to 20; and
an imaging device configured to image a projection image of the invisible light projected from the projector, in which
the projector includes a control unit configured to change a region of an image formed in an image display region of the first liquid crystal panel based on an image imaged by the imaging device.

According to this configuration, it is possible to change a region of an image of the first liquid crystal panel and move a projection image to an optimal position by using the control unit.

### Appendix 23

The projection system according to Appendix 21 or 22, further including:
a plurality of the projectors, in which
the imaging device simultaneously images the invisible light of the projection images projected respectively from the plurality of projectors, and
the control unit of each of the projectors adjusts an overlapping amount of the projection images projected from the projectors.

According to this configuration, it is possible to move the projection optical system to an optimal position with high accuracy by using the control unit, it is possible to adjust an overlapping amount in a direction in which the plurality of projection images are arranged, and it is possible to enable a viewer to recognize a naturally extended image. Further, even when positions of the plurality of the projection images change over time due to heat generation or the like, it is possible to correct the changed projection images and prevent deformation of an overlapping portion.

What is claimed is:

1. A projector comprising:
a visible light source device configured to emit visible light containing first light having a first wavelength;
an invisible light source device configured to emit invisible light;
a first light combining element configured to combine the first light and the invisible light into first combined light;
a first liquid crystal panel configured to modulate the first combined light;
a first incident-side polarizing plate configured to transmit the first light between the visible light source device and the first light combining element;
a first emission-side polarizing plate configured to transmit the first combined light at a light emission side of the first liquid crystal panel; and
a projection optical system configured to project the first combined light emitted from the first liquid crystal panel.

2. The projector according to claim 1, further comprising:
a color separation optical system configured to separate the visible light emitted from the visible light source device into the first light, second light having a second wavelength different from the first wavelength, and third light having a third wavelength different from both the first wavelength and the second wavelength;
a second liquid crystal panel configured to modulate the second light;
a third liquid crystal panel configured to modulate the third light;
a second incident-side polarizing plate configured to transmit the second light at a light incident side of the second liquid crystal panel;
a second emission-side polarizing plate configured to transmit the second light at a light emission side of the second liquid crystal panel;
a third incident-side polarizing plate configured to transmit the third light at a light incident side of the third liquid crystal panel;
a third emission-side polarizing plate configured to transmit the third light at a light emission side of the third liquid crystal panel; and
a second light combining element configured to combine the first combined light emitted from the first liquid crystal panel, the second light emitted from the second liquid crystal panel, and the third light emitted from the third liquid crystal panel into second combined light, wherein
the projection optical system projects the second combined light emitted from the second light combining element.

3. The projector according to claim 2, wherein
the first light is green light.

4. The projector according to claim 2, wherein
the first light is red light, and
the invisible light is infrared light.

5. The projector according to claim 2, wherein
the first light is blue light, and
the invisible light is infrared light.

6. The projector according to claim 1, wherein
the first light combining element is a dichroic mirror, and
the number of the dichroic mirror that transmits or reflects the invisible light between the invisible light source device and the first liquid crystal panel is one.

7. The projector according to claim 1, wherein
the invisible light source device includes a light emitting diode light source configured to emit the invisible light.

8. The projector according to claim 1, wherein
the invisible light source device includes a laser light source configured to emit the invisible light.

9. The projector according to claim 8, wherein
the invisible light source device includes a depolarizing plate configured to transmit the invisible light emitted from the laser light source and depolarize the invisible light.

10. The projector according to claim 9, wherein
the depolarizing plate includes
a first substrate,
a second substrate disposed in a manner of facing the first substrate,
a first organic film stacked on the first substrate and having no orientation regulating force that regulates an orientation direction of a liquid crystal molecule,
a second organic film stacked on the second substrate and having no orientation regulating force that regulates an orientation direction of a liquid crystal molecule, and
a liquid crystal layer disposed between the first organic film and the second organic film and containing a liquid crystal molecule disposed with a major axis direction oriented disorderly with respect to the first organic film and the second organic film.

11. The projector according to claim 1, wherein
the first light combining element is a dichroic mirror that transmits the invisible light and reflects the first light,
the dichroic mirror has a first surface on which the invisible light is incident and a second surface on which the first light is incident, and
the dichroic mirror is provided with a film that cancels out polarized light on the first surface and polarized light on the second surface.

12. The projector according to claim 1, wherein
the invisible light source device emits the infrared light having a wavelength of 930 nm or more and 950 nm or less.

13. The projector according to claim 1, wherein
the invisible light source device emits the infrared light having a wavelength of 840 nm or more and 860 nm or less.

14. The projector according to claim 1, further comprising:
a light transmitting member disposed between the first light combining element and the first emission-side polarizing plate, wherein
the light transmitting member includes
a shielding portion configured to shield the invisible light contained in the first combined light and transmit the first light, and
a transmission portion configured to transmit both the invisible light and the first light contained in the first combined light,
the transmission portion is disposed in a predetermined pattern, and
the invisible light projected by the projection optical system includes the predetermined pattern.

15. The projector according to claim 14, wherein
the light transmitting member includes a shielding plate configured to shield the invisible light and transmit the first light, and
the shielding plate is provided with a through hole having the predetermined pattern.

16. The projector according to claim 14, wherein
the invisible light source device includes
a light source configured to emit the invisible light, and
a homogenizing optical element configured to transmit the invisible light emitted from the light source and form a homogenizing irradiation pattern.

17. The projector according to claim 14, wherein
an image forming surface by the first light in the projection optical system overlaps the first liquid crystal panel, and
an image forming surface by the invisible light in the projection optical system is deviated from the light transmitting member in an axial direction of an optical path of the first combined light.

18. The projector according to claim 17, wherein
the image forming surface by the invisible light in the projection optical system is deviated from the light transmitting member to a side where the first liquid crystal panel is disposed.

19. The projector according to claim 1, further comprising:
a diffractive optical element that is disposed on an optical path of the invisible light and between the invisible light source device and the first light combining element and is configured to diffract the invisible light to form a predetermined pattern, wherein
the invisible light projected by the projection optical system includes the predetermined pattern.

20. The projector according to claim 1, wherein
the first incident-side polarizing plate is an inorganic polarizing plate.

21. A projection system comprising:
the projector according to claim 1; and
an imaging device configured to image a projection image of the invisible light projected from the projector, wherein
the projector includes
a movement mechanism configured to move the projection optical system to change a position of the projection image, and
a control unit configured to control the movement mechanism based on an image imaged by the imaging device.

22. A projection system comprising:
the projector according to claim 1; and
an imaging device configured to image a projection image of the invisible light projected from the projector, wherein
the projector includes a control unit that changes a region of an image formed in an image display region of the first liquid crystal panel based on an image imaged by the imaging device.

23. The projection system according to claim 21, further comprising:
a plurality of the projectors, wherein
the imaging device simultaneously images the invisible light of the projection images projected respectively from the plurality of projectors, and
the control unit of each of the projectors adjusts an overlapping amount of the projection images projected from the projectors.
